(19) United States
(12) Patent Application Publication
(10) Pub. No.: US 2024/0325892 A1
(43) Pub. Date: Oct. 3, 2024

(54) SYSTEM, METHOD, AND PROGRAM FOR CHARACTER TO ENCOUNTER ANOTHER CHARACTER IN VIRTUAL SPACE

(71) Applicant: GREE, Inc., Tokyo (JP)

(72) Inventors: Shinya SATO, Kanagawa (JP); Taku WATANABE, Tokyo (JP)

(73) Assignee: GREE, Inc., Tokyo (JP)

(21) Appl. No.: 18/392,572

(22) Filed: Dec. 21, 2023

(30) Foreign Application Priority Data
Mar. 31, 2023 (JP) 2023-056909

(51) Int. Cl. A63F 13/52; A63F 13/56; G06T 13/40; G06T 19/20; G06V 10/25

(52) U.S. Cl. CPC A63F 13/52; A63F 13/56; G06T 13/40; G06T 19/20; G06V 10/25; G06T 2219/2004

(57) ABSTRACT

A system for providing improvements in conventional encounter determination, which may include one or more processors. When a first character operated by a first user is present in an encounterable zone set in association with a second character in a virtual field, the one or more processors determine that the first character is in a first encounterable state in which there is a possibility of encounter between the first character and the second character. In addition, when the first character is in the first encounterable state, the one or more processors determine whether to generate a first encounter event in which the first character and the second character participate.

### FIELD

The present disclosure mainly relates to a system, method, and program for a character to encounter another character in a virtual space.

### BACKGROUND

A system is known that generates an encounter event in response to a character placed in a virtual space encountering another character. For example, a game system is known that, when a user character moving in a virtual game field encounters an enemy character, generates a battle event between the user character and the enemy character.

As methods for determining whether a user character has encountered another character, “random encounter” and “symbol encounter” methods are known.

In a game that adopts a random encounter method, a user character encounters another character with a predetermined probability (event occurrence probability) while moving in the game field. The event occurrence probability means a probability that the user character will encounter an enemy character each time the user character advances by a predetermined distance within the game field. In a game that adopts a random encounter method, whether an encounter will occur is determined probabilistically according to the event occurrence probability set in advance.

In a game that adopts a symbol encounter method, when a user character moving in a game field enters an encounter area of an enemy character in the game field, it is determined that the user character and the enemy character have encountered each other.

### SUMMARY

In a game that adopts a random encounter method, when a user character moves in a game field, an encounter event occurs at a frequency according to the event occurrence probability. Therefore, the encounter event that occurs due to the random encounter occurs forcibly while the user character is moving in the game field. Since movement or exploration in the game field is interrupted by an encounter event that occurs unexpectedly, the occurrence of an encounter event due to the random encounter may be felt as a pain to the user. In addition, in the random encounter, there is an unnaturalness in that an encounter event, with respect to an enemy character that is not displayed in a video showing the game field, suddenly starts.

In a game that adopts a symbol encounter method, an encounter event occurs forcibly when a user character enters the encounter area of an enemy character. For this reason, it is necessary to carefully determine the design of the game field or the placement of the enemy character. For example, when an enemy character is placed at a bottleneck in the game field, an encounter event with respect to the enemy character will be forced to occur each time the user character passes through the bottleneck. Thus, in conventional symbol encounters, the occurrence of an encounter event is forced when the user character approaches an enemy character. Therefore, when developing a game, the terrain of the game field and the placement of enemy characters should be appropriately determined so that the user experience is not degraded by the forced occurrence of an encounter event.

As described above, conventional encounter determination has problems that need to be solved. It is an object of various exemplary embodiments described in this specification to provide improvements in conventional encounter determination. One of the more specific objects of the various exemplary embodiments described in this specification is to provide a novel encounter determination method for determining an encounter between a user's character and another character.

In addition to the above, there are various unresolved problems in conventional encounter determination. The unresolved problems in conventional encounter determination can be clarified by referring to this entire specification. The various exemplary embodiments disclosed in this specification may solve or alleviate at least some of the problems that are described in the “Description of Embodiments” of this specification or that can be understood from the description of the “Description of Embodiments” instead of or in addition to the above-described problems. When the functions and effects of embodiments are described in this specification, the problems of the exemplary embodiments corresponding to the embodiments can be understood based on the description of the functions and effects.

A system according to an aspect of an exemplary embodiment may include one or more processors. When a first character operated by a first user is present in an encounterable zone set in association with a second character in a virtual field, the one or more processors may determine that the first character is in a first encounterable state in which there is a possibility of encounter between the first character and the second character. In addition, when the first character is in the first encounterable state, the one or more processors may determine whether to generate a first encounter event in which the first character and the second character participate.

According to an exemplary embodiment, it is possible to provide improvements in conventional encounter determination.

### BRIEF DESCRIPTION OF THE DRAWINGS

FIG. 1 is a block diagram showing a game system according to one embodiment;

FIG. 2 is a schematic diagram schematically showing a game field provided by the game system according to one embodiment;

FIG. 3a is a schematic diagram for explaining an encounterable zone used in one embodiment;

FIG. 3b is a schematic diagram for explaining an encounterable zone used in one embodiment;

FIG. 3c is a schematic diagram for explaining an encounterable zone used in one embodiment;

FIG. 3d is a schematic diagram for explaining an encounterable zone used in one embodiment;

FIG. 3e is a schematic diagram for explaining an encounterable zone used in one embodiment;

FIG. 4 is a diagram for explaining user management data stored in the game system of FIG. 1;

FIG. 5 is a diagram for explaining game medium management data stored in the game system of FIG. 1;

FIG. 6 is a diagram for explaining encounter management data stored in the game system of FIG. 1;

FIG. 7 is a flowchart for explaining the flow of encounter determination processing according to one embodiment;

FIG. 8a is a schematic diagram showing a video of a game field in the game system according to one embodiment;

FIG. 8b is a schematic diagram showing a video of a game field in the game system according to one embodiment;

FIG. 9 is a schematic diagram showing an example of a game screen when an encounter event occurs;

FIG. 10 is a schematic diagram for explaining involvement in an encounter event by a player character that does not participate in the encounter event;

FIG. 11a is a schematic diagram for explaining a modification example of the encounterable zone;

FIG. 11b is a schematic diagram for explaining a modification example of the encounterable zone;

FIG. 11c is a schematic diagram for explaining a modification example of the encounterable zone;

FIG. 11d is a schematic diagram for explaining a modification example of the encounterable zone;

FIG. 11e is a schematic diagram for explaining a modification example of the encounterable zone;

FIG. 12 is a schematic diagram for explaining a modification example of the encounterable zone;

FIG. 13 is a schematic diagram for explaining a modification example of the encounterable zone;

FIG. 14 is a schematic diagram for explaining a modification example of the encounterable zone;

FIG. 15 is a schematic diagram for explaining an encounter with another character;

FIG. 16 is a schematic diagram showing an example of a game screen when an encounter event occurs;

FIG. 17 is a schematic diagram for explaining encounters with other user characters; and

FIG. 18 is a schematic diagram showing an example of a game screen when an encounter event occurs.

### DETAILED DESCRIPTION

Hereinafter, various embodiments of the invention will be described with reference to the diagrams as appropriate. In addition, components common to a plurality of diagrams are denoted by the same reference numerals throughout the plurality of diagrams. The embodiments of the invention described below are not intended to limit the scope of the claims. The elements described in the following embodiments are not necessarily essential for the solution of the invention.

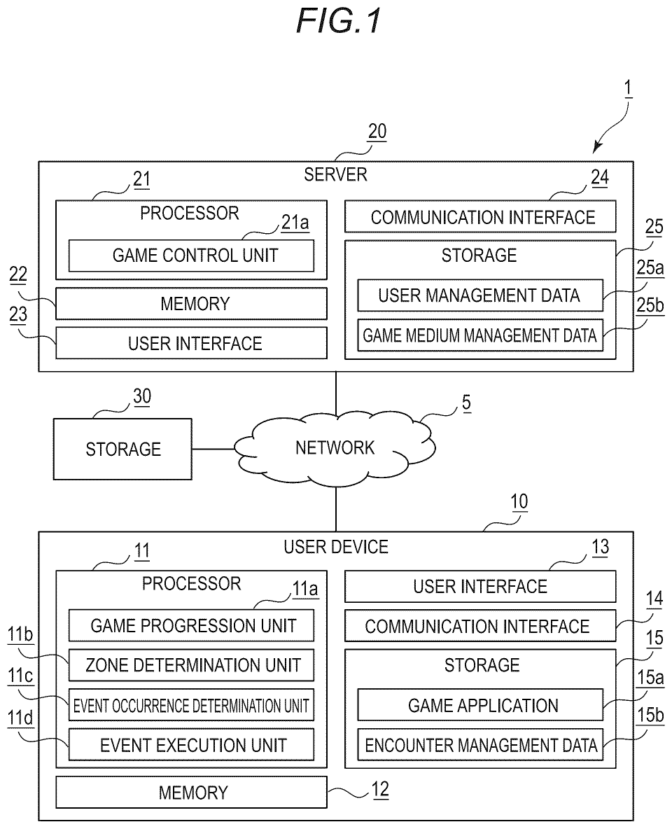

A game system 1 according to one exemplary embodiment will be described with reference to FIGS. 1 to 6. The game system 1 is an example of a system to which an exemplary embodiment disclosed in this specification can be applied. An exemplary embodiment can be applied to various applications other than games that provide a virtual space in which a character can move, but first, the game system 1, which is one embodiment, will be described with reference to FIGS. 1 to 6.

### 1. Overview of Game System 1

First, an overview of the game system 1 according to one embodiment will be given with reference to FIG. 1. FIG. 1 is a block diagram showing the game system 1. As shown in FIG. 1, the game system 1 may include a user device 10 and a server 20. The game system 1 may include a storage 30. Although one user device 10 is shown in FIG. 1 for simplicity of illustration, a plurality of user devices may be included in the game system 1. The user device 10, the server 20, and the storage 30 may be communicably connected to each other through a network 5. The network 5 may be a single network or may be configured by connecting a plurality of networks. The network 5 may be, for example, the Internet, a mobile communication network, or a combination thereof. As the network 5, any network that enables communication between electronic devices may be applied.

The user device 10 may realize various functions related to the game by executing a set of instructions included in a computer program. The server 20 can provide various services related to the game to the user device 10. The user device 10 and the server 20 can cooperate with each other as necessary to realize various functions of the game.

Not all of the elements of the game system 1 shown in FIG. 1 may be necessary to realize an exemplary embodiment. For example, the user device 10 may provide the game standalone. In this case, the server 20 may not be an essential component of the game system 1.

### 2. Overview of Game Field

In the game provided by the game system 1, the character of the user (hereinafter, referred to as “first user”) of the user device 10 and other characters may be placed in a game field constructed as a virtual space. The game field may be a virtual space provided by the game system 1. In the game field, a user character operated by the user, computer characters operated by the computer according to a predetermined algorithm, objects for expressing structures, such as buildings, or terrain, and other virtual space components may be placed. The position of each character or object in the game field can be specified by coordinate values in a three-dimensional global coordinate system set in the game field. In the game system 1, a novel mechanism for causing a user character placed in the game field to encounter a computer character may be adopted. Determination of an encounter between the user character and the computer character will be described later.

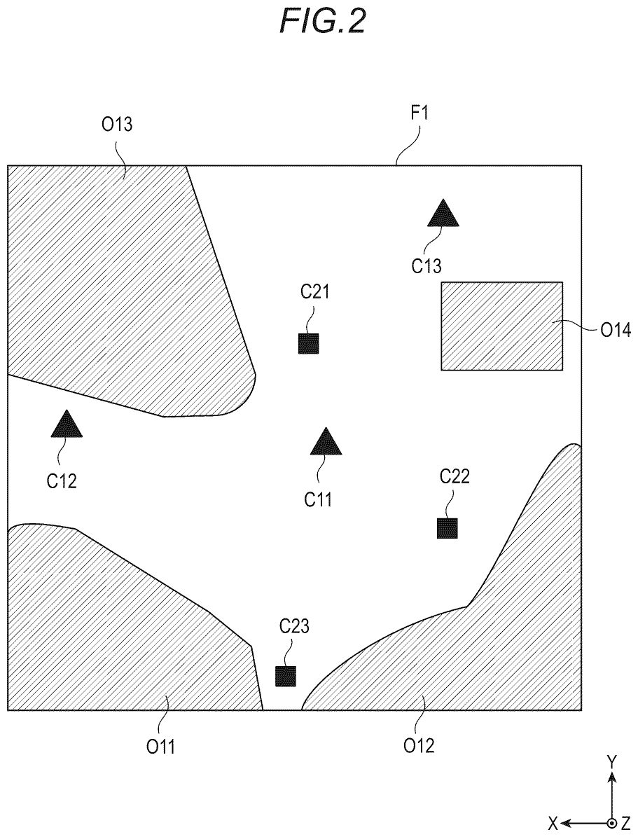

FIG. 2 shows an example of a game field. FIG. 2 schematically shows a part of a game field F1 provided by the game system 1. In the game field F1, an X axis, a Y axis, and a Z axis perpendicular to each other may be set. FIG. 2 shows a bird's-eye view of a part of the game field F1 from the Z-axis direction.

In the game field F1, one or more user characters may be placed. In the example shown, a first user character C11, a second user character C12, and a third user character C13 may be placed in the game field F1. The user characters can move in the game field F1 according to the user's operation. In this specification, it may be assumed that the first user character C11 may be the character of the first user of the user device 10. The first user can move the first user character C11 in the game field F1 through an operation on or input to a user interface 13 (described later) of the user device 10. In addition to the movement in the game field F1, the first user character C11 can take various actions in the game field F1, such as using items, in response to instructions from the first user. In this specification, the virtual space in which the user character may be placed may be referred to as a game field, but such a virtual space may also be referred to as a “world”. “Game field” in this specification can be read as “world”.

The game field F1 may be displayed on the user device 10. For example, the game field F1 may be displayed on the user device 10 as a part of the game screen together with a video of the game field F1 captured by a virtual camera provided in the game field F1. The first user can look at the game field F1 displayed on the user device 10 and may determine the movement direction of his or her first user character C11.

The game field F1 may be one of a plurality of game fields provided by the game system 1. The first user of the user device 10 can select the game field F1 among the plurality of game fields. When the game field F1 may be selected by the first user, the first user character C11 of the first user may be placed in the game field F1. When the first user selects the game field F1 and starts playing the game in the game field F1, the first user can make various settings for the game field F1. For example, the first user can set whether other users can participate in the game field F1. The game field F1 may be a closed (semi-closed) field in which the participation of other users may be restricted by the first user or conditions may be set for the participation of other users, or the game field F1 may be an open field in which users other than the first user can participate freely. The game system 1 may issue an access code to participate in the game field F1, request a user who desires to participate in the game field F1 to input the access code, and allow the user character of the user to participate in the game field F1 when the correct access code is input. The first user may publish the access code issued for the game field F1 through an in-game message or an SNS outside the game. The first user may publish the access code only to his or her friends. The second user character C12 and the third user character C13 placed in the game field F1 may be user characters of users who have participated in the game field F1 by inputting the access code provided by the first user.

The game field F1 may be a part of a larger game field. In the user device 10, a predetermined range of the game field F1 centered on the first user character C11 may be displayed. That is, the game field F1 displayed on the user device 10 may be a part of the entire game field in which the first user character C11 can move, centered on a position where the first user character C11 may be placed. For example, when the first user character C11 is placed at point A in the game field F1, a predetermined area of the entire game field centered on the point A may be displayed as the game field F1. When the first user character C11 moves from point A to point B, a predetermined area of the entire game field centered on the point B may be displayed as the game field F1 after the movement.

The user (hereinafter, referred to as “second user”) of the second user character C12 can operate the second user character C12 in the game field F1 by operating his or her own user device. Similarly, the user (hereinafter, referred to as “third user”) of the third user character C13 can operate the third user character C13 in the game field F1 by operating his or her own user device. The user device of the second user and the user device of the third user may be examples of the user device included in the game system 1 and have the same functions as the user device 10.

In addition to the user characters, one or more computer characters operated by the computer according to a predetermined algorithm may be placed in the game field F1. In the example shown, a first computer character C21, a second computer character C22, and a third computer character C23 may be placed in the game field F1. The game system 1 may be configured to, when a user character encounters a computer character in the game field F1, generate an encounter event in which the user character and the computer character that have encountered each other participate. The first computer character C21, the second computer character C22, and the third computer character C23 may be enemy characters that fight against the user character. When a user character and an enemy character encounter each other, a battle event between the user character and the enemy character may be started as an encounter event. The first computer character C21, the second computer character C22, and the third computer character C23 may move in the game field F1 according to a movement pattern generated by generative AI such as ChatGPT.

The first computer character C21, the second computer character C22, and the third computer character C23 may be placed in the game field F1 from the time of generation of the game field F1. Some of the first computer character C21, the second computer character C22, and the third computer character C23 may be set to appear (be newly placed) in the game field F1 only when predetermined conditions are satisfied in the game field F1. The appearance of a computer character in the game field F1 may be expressed as “spawning”. For example, the second computer character C22 may be a boss character, and may be spawned in the game field F1 after predetermined conditions are satisfied from the generation of the game field F1. The conditions for the second computer character C22 to spawn in the game field F1 may include “a predetermined amount of time has passed from the generation of the game field F1”, “a predetermined number of computer characters have been defeated in the game field F1”, “a predetermined item has been acquired in the game field F1”, and other conditions.

Various objects may be placed in the game field F1. In the example shown, a first object O11, a second object 012, a third object O13, and a fourth object O14 may be placed in the game field F1. The object placed in the game field F1 may be fixed at a predetermined position in the game field F1, or may be movable in the game field F1. Each of the first object O11, the second object O12, the third object O13, and the fourth object O14 may be an object representing a structure, an object representing a natural terrain such as a mountain, a hill, a river, and a forest, and any object that can be placed in the game field F1 other than those mentioned above. Objects placed in the game field F1 may include an object that the first user character C11 cannot enter. In the example shown, it may be assumed that the first user character C11 cannot enter the area occupied by the first object O11 and the second object O12. Therefore, a bottleneck may be formed between the first object O11 and the second object O12, and the third computer character C23 may be placed at the bottleneck.

### 3. Overview of Encounter Determination

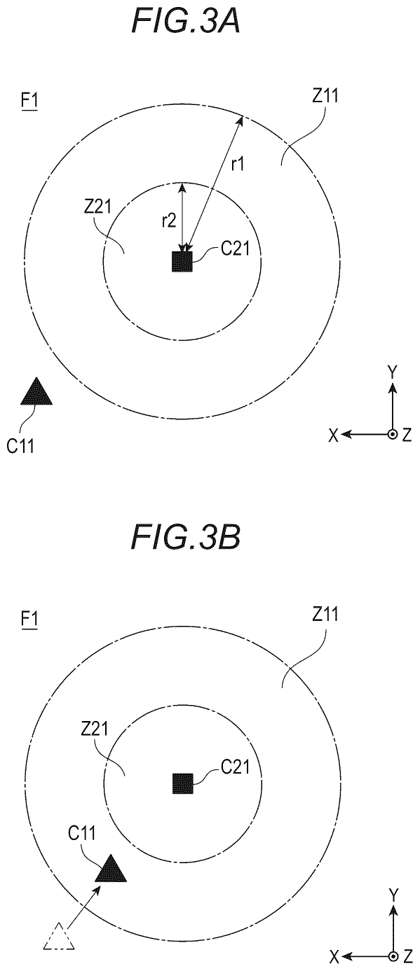

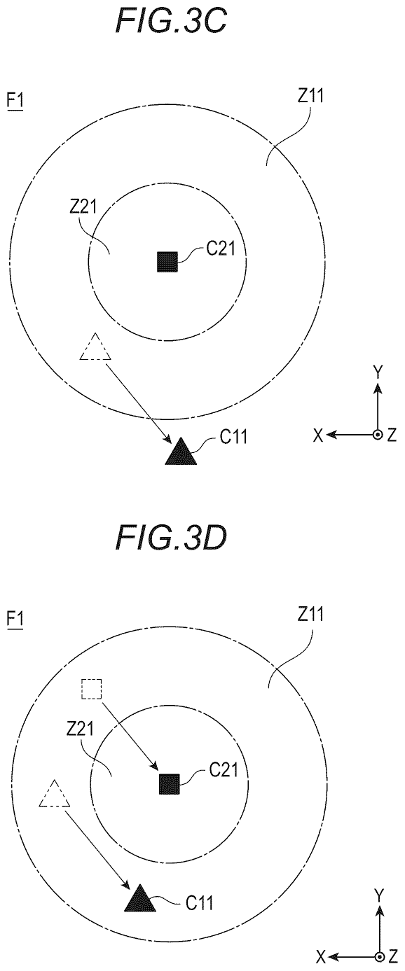

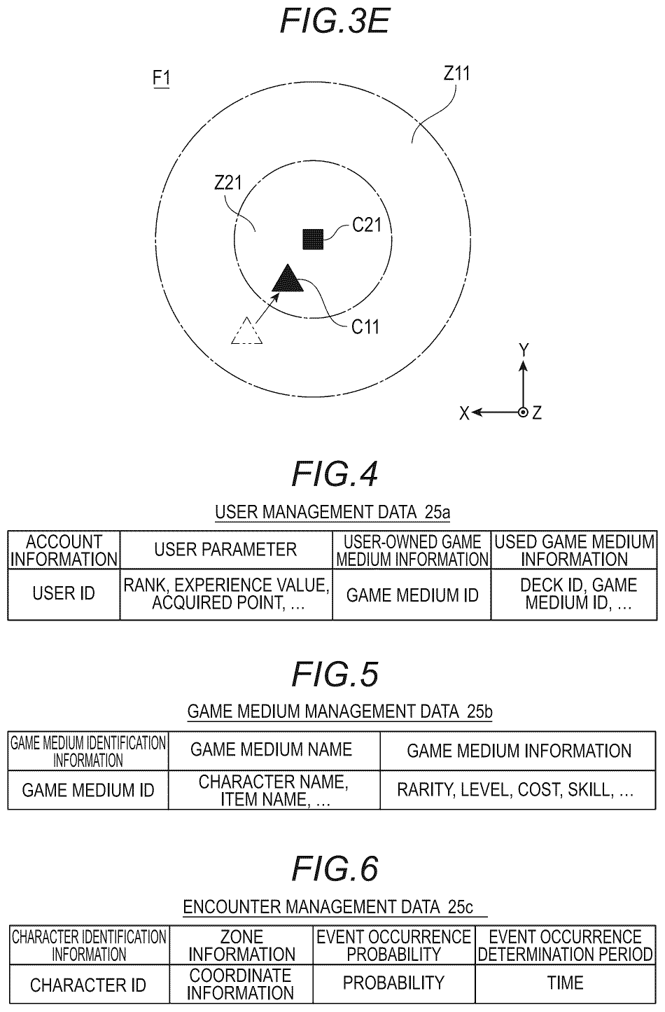

Next, an overview of encounter determination that can be adopted in the game provided by the game system 1 will be given with reference to FIGS. 3a to 3e. In FIGS. 3a to 3e, the first user character C11 and the first computer character C21 may be shown. Hereinafter, a determination regarding whether the first user character C11 encounters the first computer character C21 (determination of encounter between the first user character C11 and the first computer character C21) will be described, but this encounter determination can also be applied to determination of encounter between other characters.

In the encounter determination in the game system 1, (1) it may be determined whether the first user character C11 is present in an encounterable zone Z11 of the first computer character C21, and (2) when the first user character C11 is present in the encounterable zone Z11, an event occurrence determination may be performed to determine whether to generate an encounter event in which the first user character C11 and the first computer character C21 participate. That is, the encounter determination may be performed in two stages of zone determination, which may be performed to determine whether the first user character C11 is present in the encounterable zone Z11, and event occurrence determination, which may be performed when the first user character C11 is present in the encounterable zone Z11. Specifically, in (1) above, it may be determined that the first user character C11 is present in the encounterable zone Z11 of the first computer character C21. When it is determined that an encounter event is to occur in (2), the first user character C11 may encounter the first computer character C21 and an encounter event occurs. An encounter between the first user character C11 and the first computer character C21 does not occur simply by the first computer character C21 entering the encounterable zone Z11.

### 3-1. Encounterable Zone

First, an encounterable zone set for the first computer character C21 will be described. As shown in FIG. 3a, in the game field F1, the encounterable zone Z11 may be set in association with the first computer character C21. In the example shown, a zone located within a first distance r1 from the coordinates of the position where the first computer character C21 may be placed in the XY plane may be set as the encounterable zone Z11. That is, in the example shown, the encounterable zone Z11 may be within a circle having a radius r1 centered on the first computer character C21. The encounterable zone Z11 may be defined three-dimensionally in the game field F1. For example, the encounterable zone Z11 may be a zone within a sphere having a radius r1 centered on the position where the first computer character C21 is placed.

In the example of FIG. 3a, in the game field F1, the first user character C11 may be placed outside the encounterable zone Z11 set for the first computer character C21. Therefore, it may be determined that the first user character C11 cannot encounter the computer character C21. When the first user character C11 cannot encounter the first computer character C21, the first user character C11 may be in a normal state.

When the first user character C11 moves in a direction approaching the first computer character C21 from the position shown in FIG. 3a in the game field F1, the first user character C11 may enter the encounterable zone Z11 as shown in FIG. 3b. In the example of FIG. 3b, the first user character C11 may be placed inside the encounterable zone Z11 set for the first computer character C21. Therefore, it may be determined that the first user character C11 is in an encounterable state in which there is a possibility of encounter between the first user character C11 and the first computer character C21. That is, when the first user character C11 enters the encounterable zone Z11 of the first computer character C21, the first user character C11 may transition from the normal state to the encounterable state.

As shown in FIG. 3c, the first user character C11 can move from a position inside the encounterable zone Z11 to a position outside the encounterable zone Z11 in response to the first user's operation. When the first user character C11, which has entered the encounterable zone Z11 to be in an encounterable state, moves outside the encounterable zone Z11, the encounterable state of the first user character C11 may be canceled. That is, when the first user character C11 moves from the inside to the outside of the encounterable zone Z11, the first user character C11 may transition from the encounterable state to the normal state.

The first computer character C21 may be controlled to track the first user character C11 that has left the encounterable zone Z11. For example, as shown in FIG. 3d, the first computer character C21 may move to track the first user character C11 when the first user character C11 leaves the encounterable zone Z11. As shown in FIG. 3d, this may cause the first user character C11 to enter the encounterable zone Z11 again by being tracked by the first computer character C21 after leaving the encounterable zone Z11.

Whether the first user character C11 is placed inside the encounterable zone Z11 can be determined according to whether the coordinates of the position where the first user character C11 is placed on the XY plane are within the encounterable zone Z11. Whether the first user character C11 is placed in the encounterable zone Z11 can be determined every predetermined zone determination period. The zone determination period may be set to a time that allows it to be determined substantially in real time whether the first user character C11 is placed in the encounterable zone Z11. The zone determination period may be, for example, 0.1 seconds, or may be shorter or longer than 0.1 seconds.

### 3-2. Determination of Occurrence of Event in the Encounterable Zone

In response to the transition of the first user character C11 to the encounterable state, an event occurrence determination may be performed to determine whether to generate an encounter event in which the first user character C11 and the first computer character C21 participate. In this specification, the determination regarding whether to generate an encounter event in which a user character and another character (for example, a computer character) participate, which may be performed when the user character is in an encounterable state for another character, may be referred to as “event occurrence determination”. The event occurrence determination can be performed in various methods. Hereinafter, an example of the event occurrence determination when the first user character C11 is in an encounterable state for the first computer character C21 will be described. In this specification, for ease of description, the encounter event in which the first user character C11 and the first computer character C21 participate may be referred to as a “first encounter event”.

In one aspect, the event occurrence determination may be performed based on the event occurrence probability. For example, while the first user character C11 is in an encounterable state, a determination regarding whether to generate an encounter event may be repeatedly performed based on the event occurrence probability each time a predetermined amount of time passes. That is, the event occurrence determination may be repeatedly performed every predetermined event occurrence determination period after the first user character C11 transitions to the encounterable state. The event occurrence determination period may be, for example, 1 second, or may be longer or shorter than 1 second. The elapsed time from the transition of the first user character C11 to the encounterable state can be measured based on the system clock.

The event occurrence probability used to may determine the occurrence of an event between the first user character C11 and the first computer character C21 indicates a probability that the first encounter event occurs in one determination when the first user character C11 is in an encounterable state in which there may be a possibility of encounter between the first user character C11 and the first computer character C21 (that is, when the first user character C11 may be present in the encounterable zone Z11 of the first computer character C21). When the event occurrence probability is fixed, the event occurrence probability takes a value less than 100%. The event occurrence probability may be 50% or less, 30% or less, 20% or less, or 10% or less. The event occurrence probability may be, for example, 10%, or may be larger or smaller than 10%. The event occurrence probability may change. When the event occurrence probability changes, the event occurrence probability may be temporarily set to 100%.

The event occurrence probability may be set to fall within a range in which the occurrence of an encounter event with respect to the first computer character C21 can be avoided by leaving the encounterable zone Z11 after the first user character C11 initially enters the encounterable zone Z11. For example, when the event occurrence determination period is set to 1 second and the event occurrence probability is set to 10%, a probability that an encounter event will not occur until 5 seconds passes from the transition of the first user character C11 to the encounterable state may be approximately 59% ((9/10) to the 5th power). In this case, as long as the first user can exit the encounterable zone Z11 within 5 seconds after entering the encounterable zone Z11, the first user can avoid encountering the first computer character C21 with a probability of approximately 59%. When the event occurrence probability for each event occurrence determination period of 1 second is set to 20%, a probability that an encounter event will not occur until 5 seconds passes may be approximately 33% ((4/5) to the 5th power). By setting the event occurrence probability in this manner, it may be possible to determine the ease of avoiding encounters after the transition of the user character to the encounterable state. In addition, by changing the event occurrence determination period, the ease of avoiding encounters can be changed. Specifically, as the event occurrence determination period decreases, the number of determinations per predetermined time increases, and accordingly, encounters may be more likely to occur. For example, when the event occurrence determination period is set to 0.5 seconds and the event occurrence probability is set to 10%, a probability that an encounter event will not occur until 5 seconds passes may be approximately 35% ((9/10) to the 10th power). Therefore, encounters may be more likely to occur compared with a case where the event occurrence determination period is 1 second. The event occurrence determination period used to determine the occurrence of an event between a certain user character and another computer character may be determined individually for each computer character.

The event occurrence probability used to determine the occurrence of an event between a certain user character and another computer character may be determined individually for each computer character. For example, the event occurrence probability may be determined individually for the first computer character C21, the second computer character C22, and the third computer character C23 placed in the game field F1.

The event occurrence probability used to determine the occurrence of an event between a certain user character and another computer character may be determined individually for each user character. For example, the event occurrence probability may be determined individually for the first user character C11, the second user character C12, and the third user character C13 placed in the game field F1.

The event occurrence determination may be performed by using a common event occurrence probability that may be commonly used for the characters placed in the game field F1.

The event occurrence probability may change with the time elapsed from the transition of the user character to the encounterable state. For example, the event occurrence probability may gradually increase according to the elapsed time (staying time in the encounterable zone Z11) after the first user character C11 enters the encounterable zone Z11. An upper limit may be set for the gradually increasing event occurrence probability. The upper limit of the event occurrence probability may be, for example, 50%. The event occurrence probability after gradual increase may reach 100%.

The event occurrence probability between a user character and another character may change according to the distance between the characters in the game field F1. For example, the event occurrence probability may increase as the distance between the first user character C11 and the first computer character C21 decreases. When the first user does not desire to encounter the first computer character C21, the first user character C11 can be moved away from the first computer character C21 in the game field F1 to avoid encountering the first computer character C21.

In one aspect, the event occurrence determination may be performed based on an event occurrence gauge. For example, the event occurrence gauge can take a value between 0 and 100, and it may be determined that the first user character C11 has encountered the first computer character C21 when the event occurrence gauge reaches 100. That is, when the event occurrence gauge reaches its maximum value, it may be determined that the first encounter event will occur. In this specification, the maximum value that the event occurrence gauge can take may be referred to as an “event occurrence value”. The value of the event occurrence gauge may increase each time a predetermined amount of time passes. For example, the value of the event occurrence gauge may increase by 10 every 1 second from the transition of the first user character C11 to the encounterable state. In this case, when the first user character C11 remains in the encounterable zone Z11 for 10 seconds, it may be determined that the first encounter event will occur. The value of the event occurrence gauge may gradually increase or may increase or decrease while the first user character C11 may be in the encounterable zone Z11. The event occurrence value may be individually determined for each computer character, or may be commonly determined for all computer characters. The event occurrence value may increase or decrease as the game progresses. The value of the event occurrence gauge may be reset to 0 (zero) in response to the first user character C11 leaving the encounterable zone Z11. The value of the event occurrence gauge may not be reset even when the first user character C11 leaves the encounterable zone Z11, and when the first user character C11 re-enters the encounterable zone Z11 after leaving, the value of the event occurrence gauge may be set to return to the value when the first user character C11 left the encounterable zone Z11 previously. The rate of increase in the value of the event occurrence gauge, the mode of increase or decrease in the value of the event occurrence gauge, and/or whether to reset the event occurrence gauge when the first user character C11 leaves the encounterable zone Z11 may be determined individually for each computer character.

### 3-3. Contact Zone

Next, a contact zone set for the first computer character C21 will be described. As shown in FIG. 3a, in the game field F1, a contact zone Z21 may be set in association with the first computer character C21. In the example shown, a zone located within a second distance r2 smaller than the first distance r1 from the coordinates of the position where the first computer character C21 is placed in the XY plane is set as the contact zone Z21. That is, in the example shown, the contact zone Z21 may be within a circle having a radius r2 centered on the first computer character C21. The contact zone Z21 may be a three-dimensionally defined zone in the game field F1. For example, the contact zone Z21 may be a zone within a sphere having a radius r2 centered on the position where the first computer character C21 is placed.

When the first user character C11 the encounterable zone Z11 as shown in FIG. 3b from the position shown in FIG. 3a and moves from the position shown in FIG. 3b in a direction closer to the first computer character C21, the first user character C11 may enter the contact zone Z21 set for the first computer character C21 as shown in FIG. 3e. In one aspect, when the first user character C11 the contact zone Z21 set for the first computer character C21, it may be d that the first user character C11 has encountered the first computer character C21, and the first encounter event occurs. That is, when the first user character C11 the contact zone Z21, the first user character C11 may automatically encounter the first computer character C21. Whether the first user character C11 is inside or outside the contact zone Z21 can be determined according to whether the coordinates of the position where the first user character C11 is placed in the XY plane are within a circle having a radius r2 centered on the coordinates of the position where the first computer character C21 is placed in the XY plane.

For the first computer character C21, the contact zone Z21 may not be set. That is, the contact zone Z21 may not be an essential element in encounter determination. A contact zone may be set for some of the computer characters placed in the game field F1, and no contact zone may be set for the other computer characters.

### 4. User Device

Next, the user device 10 will be further described with reference to FIG. 1 again.

### 4-1. User Device Configuration

The user device 10 may be a smartphone, a personal computer (PC), a mobile phone, a tablet terminal, a personal computer, an electronic book reader, a wearable computer, a game console, a head-mounted display, or various other information processing devices. The user device 10 may be assumed to be used by the first user. The first user can play the game through input to the user device 10 and through images or sounds output from the user device 10.

The user device 10 may include a processor 11, a memory 12, a user interface 13, a communication interface 14, and a storage 15.

The processor 11 may be a calculation device that loads an operating system or various other programs from the storage 15 or other storages to the memory 12 and executes instructions included in the loaded programs. The processor 11 may be, for example, a CPU, an MPU, a DSP, a GPU, various other calculation devices, or a combination thereof. The processor 11 may be realized by an integrated circuit such as an ASIC, a PLD, an FPGA, or an MCU.

The memory 12 may be used to store instructions executed by the processor 11 and various other pieces of data. The memory 12 may be a main memory that can be accessed by the processor 11 at high speed. The memory 12 may be, for example, a RAM such as a DRAM or an SRAM.

The user interface 13 may include an input interface for receiving a user input and an output interface for outputting various kinds of information under the control of a processor 21. The input interface may be a keyboard, a pointing device such as a mouse, a touch panel, or any other information input device capable of inputting a user input. The output interface may be, for example, a liquid crystal display, an organic EL (Electro-Luminescence) display, a display panel, or any other information output device capable of outputting the calculation results of the processor 11.

The communication interface 14 may be implemented as hardware, firmware, communication software such as a TCP/IP driver or a PPP driver, or a combination thereof. The user device 10 can transmit and receive data to and from other information devices including the server 20 through the communication interface 14.

The storage 15 may be an external storage device accessed by the processor 11. The storage 15 may be, for example, a magnetic disk, an optical disk, a semiconductor memory, or various other storage devices capable of storing data.

### 4-2. Data Stored in Storage 15

The storage 15 may store a game application 15a for providing various game functions, encounter management data 15b used for encounter determination, and various other kinds of data.

Instructions included in the game application 15a can be executed by the processor 11. Details of the functions realized by executing the game application 15a will be described later. The game application 15a may be downloaded to the user device 10 from, for example, an application distribution platform (not shown). The user device 10 can acquire data necessary for progressing with the game part from the server 20 and store the acquired data in the storage 15, as necessary.

The encounter management data 15b will be described with reference to FIG. 4. The encounter management data 15b may be a data set in which data referred to when determining an encounter may be stored in a structured manner. The encounter management data 15b may include, for example, character identification information for identifying computer characters placed in the game field. In addition to the character identification information of the computer characters, the encounter management data 15b can include zone information, an event occurrence probability, and an event occurrence determination period set for each computer character.

The zone information of a computer character may indicate the range of an encounterable zone set for the computer character. The zone information may be coordinate information indicating an encounterable zone. For example, when the encounterable zone is circular, the zone information can include coordinates indicating the position of the computer character in the game field and the radius of the circle defining the outer edge of the encounterable zone. The zone information of the computer character may be updated to reflect the latest position of the computer character moving in the game field. The zone information may be changed according to user settings. For example, when two or more modes are available in a game depending on the user's selection, different zone information may be set for each mode. Specifically, when the game has a hard mode in which encounters occur frequently and an easy mode in which encounters occur less frequently, zone information may be determined so that a wider encounterable zone may be set when the hard mode is selected. The zone information may be updated or changed in response to an event other than the user's selection.

As described above, the event occurrence probability set for a computer character may indicate an occurrence probability used in one determination of an encounter event in which a user character and a computer character participate, under a circumstance when the user character is in a state where it is possible for the user character to encounter the computer character. This occurrence probability, which may for example allow for a single determination to be made regarding whether an encounter occurs, may be stored as a part of encounter management data 25c. Similarly to the zone information, the event occurrence probability may also be changed according to the user's mode selection or an event other than the user's mode selection.

The event occurrence determination period set for a computer character may indicate an interval at which event occurrence determination may be repeatedly performed for a user character that is in an encounterable state with respect to the computer character. Similarly to the zone information and the event occurrence probability, the event occurrence determination period may also be changed according to the user's mode selection or an event other than the user's mode selection.

### 4-3. User Device Functions

The processor 11 of the user device 10 functions as a game progression unit 11a, a zone determination unit 11b, an event occurrence determination unit 11c, and an event execution unit 11d by executing an instruction set included in the game application 15a and other instruction sets as necessary.

### 4-3-1. Game Progression Unit 11a

The game progression unit 11a advances a game according to the instruction set included in the game application 15a and, when necessary, based on an input from the first user through the user interface 13 (for example, a touch panel) of the user device 10. The game progression unit 11a can also advance the game in cooperation with the server 20. Operational inputs from the user may include, for example, an input for selecting a game field, an input for specifying the movement of the first user character C11 in the game field, an input for giving an instruction for use of items, an input for changing game settings, and various other inputs related to the progress of the game. The game progression unit 11a can generate a request related to the progress of the game based on an instruction set included in the game application 15a and an input from the user and transmit the generated request to the server 20, for example. In addition, the game progression unit 11a can receive various kinds of game data related to the progress of the game from the server 20 and advance the game based on the game data. The game progression unit 11a can display a video on the user interface 13 (for example, a display) according to the progress of the game. For example, the game progression unit 11a can generate a video of the game field F1 generated by rendering.

The game progression unit 11a may acquire data necessary for advancing the game among various kinds of data stored in a storage 25 of the server 20 and store the acquired data in the storage 15. The game progression unit 11a can read data as appropriate from the storage 15 and perform a calculation using the read data when this is necessary for game processing.

### 4-3-2. Zone Determination Unit 11b

The zone determination unit 11b may determine in which zone the user character placed in the game field is present among various zones set in the game field. As shown in FIG. 2, when the first user character C11 is placed in the game field F1, the zone determination unit 11b can determine, based on the coordinates of the first user character C11 in the game field F1, whether the first user character C11 is placed in the encounterable zone of any computer character placed in the game field F1. For example, the zone determination unit 11b can determine whether the first user character C11 is placed in the encounterable zone Z11 set for the first computer character C21 based on the coordinates of the position of the first user character C11 in the game field F1. When the first user character C11 is placed outside the encounterable zone Z11 set for the first computer character C21 as shown in FIG. 3a, the zone determination unit 11b may determine that the first user character C11 is placed outside the encounterable zone Z11 set for the first computer character C21. In this case, the zone determination unit 11b may determine that the first user character C11 is not in an encounterable state (that is, is in a normal state) in which there is a possibility of encounter between the first user character C11 and the first computer character C21. On the other hand, when the first user character C11 is placed inside the encounterable zone Z11 (but outside the contact zone Z21) as shown in FIG. 3b, the zone determination unit 11b may determine that the first user character C11 is placed inside the encounterable zone Z11 set for the first computer character C21. In this case, the zone determination unit 11b may determine that the first user character C11 is in an encounterable state in which there is a possibility of encounter between the first user character C11 and the first computer character C21. When the first user character C11 leaves the encounterable zone Z11 (that is, when the first user character C11 moves out of the encounterable zone Z11) as shown in FIG. 3c, the zone determination unit 11b may determine that the first user character C11 is not in an encounterable state in which there is a possibility of encounter between the first user character C11 and the first computer character C21.

The zone determination unit 11b can determine whether the first user character C11 is placed in any zone set in the game field F1 every predetermined zone determination period. For example, the zone determination unit 11b can determine whether the first user character C11 is placed in the encounterable zone Z11 (or other encounterable zones) every zone determination period. The zone determination period may be short enough to detect whether the first user character C11 is placed in the encounterable zone Z11 in substantially real time. The zone determination period may be 1 second or less, 0.5 seconds or less, 0.3 seconds or less, 0.2 seconds or less, or 0.1 seconds or less.

As described above, the zone determination unit 11b can determine whether the first user character C11 is placed in the encounterable zone Z11 in substantially real time, and may determine according to the determination result whether the first user character C11 is in an encounterable state in which there is a possibility of encounter between the first user character C11 and the first computer character C21. Similarly, the zone determination unit 11b can determine whether the first user character C11 is placed in an encounterable zone set for computer characters other than the first computer character C21. In addition, for a user character other than the first user character C11 as well, the zone determination unit 11b can similarly determine whether the user character is placed in the encounterable zone set for the computer character placed in the game field F1.

The zone determination unit 11b can determine whether the first user character C11 is placed in a contact zone (for example, the contact zone Z21) set for a computer character (for example, the first computer character C21) placed in the game field F1. For a user character other than the first user character C11 as well, the zone determination unit 11b can similarly determine whether the user character is placed in the contact zone set for the computer character placed in the game field F1.

### 4-3-3. Event Occurrence Determination Unit 11c

The event occurrence determination unit 11c may determine whether to generate a first encounter event in response to the zone determination unit 11b determining that the first user character C11 is in an encounterable state. This event occurrence determination can be performed based on the event occurrence probability, as described above. For example, when the first user character C11 is in an encounterable state, the event occurrence determination unit 11c may probabilistically determine whether the first encounter event will occur based on the event occurrence probability every event occurrence determination period. When the event occurrence determination period is 1 second, the event occurrence determination unit 11c may determine whether the first encounter event will occur every second as long as the first user character C11 is in the encounterable state. When the event occurrence probability is 20%, it may be determined that an encounter event will occur with a probability of 20% in one determination. Therefore, when the first computer character C21 stays in the encounterable zone Z11 for a long time, the possibility that an encounter event will occur increases. On the contrary, even if the first computer character C21 once enters the encounterable zone Z11, when the first user character C11 leaves the encounterable zone Z11 immediately after entering, the possibility that an encounter event will occur may be low.

When the zone determination unit 11b determines that the first user character C11 is placed in the contact zone Z21, the event occurrence determination unit 11c may determine that the first encounter event has occurred.

### 4-3-4. Event Execution Unit 11d

The event execution unit 11d may execute a first encounter event when the event occurrence determination unit 11c determines that an encounter event has occurred. The encounter event may be, for example, a battle event in which the first user character C11 and the first computer character C21 fight. The encounter event is not limited to the battle event. The encounter event may be a communication event in which the first user character C11 and the first computer character C21 have a conversation. The encounter event may be a transaction event in which the first user character C11 and the first computer character C21 trade game media such as items. The encounter event executed by the event execution unit 11d is not limited to those explicitly described in this specification.

### 5. Server Apparatus

Next, the server 20 will be further described. The server 20 may include a processor 21, a memory 22, a user interface 23, a communication interface 24, and a storage 25. The above explanation regarding the processor 11, the memory 12, the user interface 13, the communication interface 14, and the storage 15 of the user device 10 also applies to the processor 21, the memory 22, the user interface 23, the communication interface 24, and the storage 25.

The storage 25 may store user management data 25a, game medium management data 25b, and other data necessary for providing the game.

The user management data 25a will be described with reference to FIG. 5. The user management data 25a may be a data set in which various kinds of data related to the user who plays the game provided by the game system 1 may be stored in a structured manner. The user management data 25a can include user account information, various parameters set for the user, user-owned game medium information regarding the game medium owned by the user, used game medium information regarding the used game medium used by the user in the game, and various other kinds of data regarding the user.

The account information may be, for example, a user ID for identifying the user. The account information may include a username. In the game system 1, a user may be uniquely identified by the user ID. The username may indicate the name of the user used in the game.

The parameters of a certain user may include the user's rank, experience values, acquired points, and other user parameters associated with the user that change as the user plays the game. The user's rank may be a parameter indicating the user's skill level regarding the game. The rank may increase according to the user's play of the game.

The user-owned game medium information may be information regarding the game medium owned by the user in the game. The game medium may be electronic data used in the game. Examples of the game medium can include characters, cards, items, points, in-service currency (or in-game currency), tokens (for example, Non-Fungible Token (NFT)), tickets, avatars, parameters, and other electronic data used in the game. The game medium can be acquired, owned, used, managed, exchanged, synthesized, enhanced, sold, discarded, gifted, and the like in the game by the user. The game medium may be used in methods other than those described above. The user-owned game medium information can include a game medium ID for identifying the game medium owned by the user in the game. When the game medium may be acquired by the user, a game medium ID for specifying the game medium may be stored as user-owned game medium information in association with the user ID of the user. Hereinafter, unless otherwise specified, a game medium “owned” by the user refers to a game medium associated with the user ID of the user. In addition, “granting” the game medium to the user means associating the game medium with the user ID of the user as a game medium “owned” by the user. In addition, “discarding” the game medium owned by the user means canceling the association between the user ID of the user and the game medium. In addition, “consuming” the game medium owned by the user means generating an effect in the game in response to the cancellation of the association between the user ID and the user-owned game medium. In addition, “selling” the game medium owned by the user means canceling the association between the user ID of the user and the game medium and associating another game medium (for example, virtual currency or items) with the user ID as a user-owned game medium. In addition, “transferring” the game medium owned by a user A to a user B means canceling the association between the user ID of the user A and the game medium and associating the game medium with the user ID of the user B. In addition, “creating” a game medium refers to defining or determining at least a part of information regarding the game medium.

The used game medium information may be information indicating the game medium used by the user in the game part (for example, battle game part). The game medium used by the user in the battle game part may be selected from among the user-owned game media. The game medium used by the user in the battle game part may be selected in response to user operation selection or automatically selected among the used game media. Once a used game medium is selected to execute a battle game part, a deck may be configured by the used game medium. In this case, the used game medium information may include a deck ID for identifying the deck including the game medium selected as a used game medium.

The user management data 25a may include friend information. Friend information regarding a certain user may indicate the user ID of a user who is a friend with the user. For example, when a user A is friends with users B and C, friend information of the user A may include the user IDs of the users B and C. Users who are friends can cooperate to play the game.

A part of the data stored as the user management data 25a may be updated as needed as the game progresses. For example, the user's rank increases as the user plays the game. A part of the data stored as the user management data 25a may not be updated as the game progresses. For example, the user ID may remain unchanged even as the game progresses.

The game medium management data 25b will be described with reference to FIG. 6. The game medium management data 25b may be a data set in which various kinds of data related to game media used in the game provided by the game system 1 are stored in a structured manner. The game medium management data 25b may include game medium identification information of various game media, game medium names, game medium information indicating the characteristics of game media, and various other data regarding game media.

The game medium ID may be an ID for identifying the game medium. The game medium name may indicate the name of the game medium.

The game medium information may include various kinds of information indicating the characteristics of the game medium. The game medium information may include, for example, rarity, level, cost, life, attack power, defense power, and game function information. Rarity may be information indicating the rarity (rarity value) of the game medium. That is, the rarity associated with a certain game medium may indicate the difficulty of acquiring the game medium. The level may indicate the degree of growth of the game medium. For example, the greater the value of the level, the greater the degree of growth of the game medium. In the present embodiment, the value of the level may increase according to the user's play of the game. The cost may be a parameter used when determining the deck to be used in the battle game part. For example, an upper limit of the total cost of game media that can be included in the deck may be set for the deck. The user can select game media to be included in the deck such that the total cost does not exceed the upper limit.

The life may be a parameter used to determine the victory or defeat of the user in the battle game part. In the battle game part, the life may be reduced when the user character is attacked by the enemy character. The life may be restored to the upper limit or a value lower than the upper limit by using a recovery item. When the life of all the characters included in the user's deck becomes zero, it may be determined that the user has lost the battle game part.

The attack power of the game medium may be a parameter that contributes to the amount of damage inflicted on the enemy character by the attack of the game medium. The greater the value of attack power, the greater the amount of damage inflicted on the enemy character. The defense power of the game medium may be a parameter that contributes to the amount of damage that the game medium receives due to attacks from the enemy character. The greater the value of defense power, the smaller the amount of damage received from attacks from the enemy character.

The game medium information may include game function information. The game function information associated with the game medium may indicate a game function for the game medium to generate a game effect in the game part. In the relevant technical field, the game function may be referred to as a skill or ability. Depending on the game, “spells” used by characters also fall under the game function. When a game function is used in a game part, a game effect associated with the game function may be generated. The game effect generated by using the game function in the battle game part may include an increase in attack power, an increase in defense power, recovery of life, and other effects that affect the victory or defeat of the battle with the enemy character.

At least some of the user management data 25a and the game medium management data 25b may be referred to by the user device 10 as necessary. At least some of the user management data 25a and the game medium management data 25b may be stored in the user device 10 as necessary.

The processor 21 of the server 20 functions as a game control unit 21a by executing the instruction set included in the program stored in the storage 25 and other instruction sets as necessary. The game control unit 21a can control the progress of the game by processing a request or notification from the user device 10 based on predetermined game logic and providing the user device 10 with various kinds of game data for executing the game.

### 6. Flow of Encounter Determination

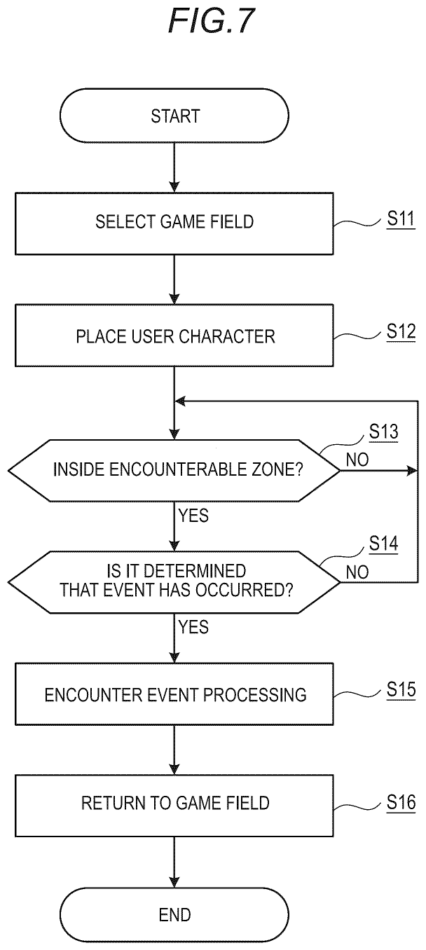

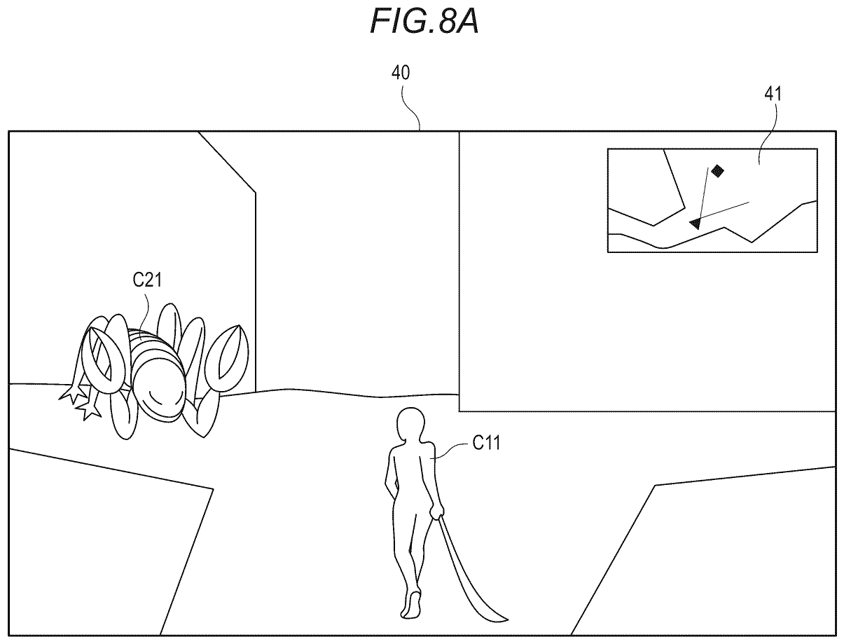

Next, the flow of processing for encounter determination will be described with reference to FIG. 7. The processing shown in FIG. 7 may be performed by the processor 11 of the user device 10 executing instructions included in the game application 15a. A part of the processing shown in FIG. 7 may be performed by a processor (for example, the processor 21 of the server 20) provided in a device other than the user device 10. In FIG. 7, it may be assumed that the first user uses the user device 10 to play a game provided by the game system 1 using the first user character C11. This game has a plurality of game fields, and the first user can select a favorite game field among the plurality of game fields.

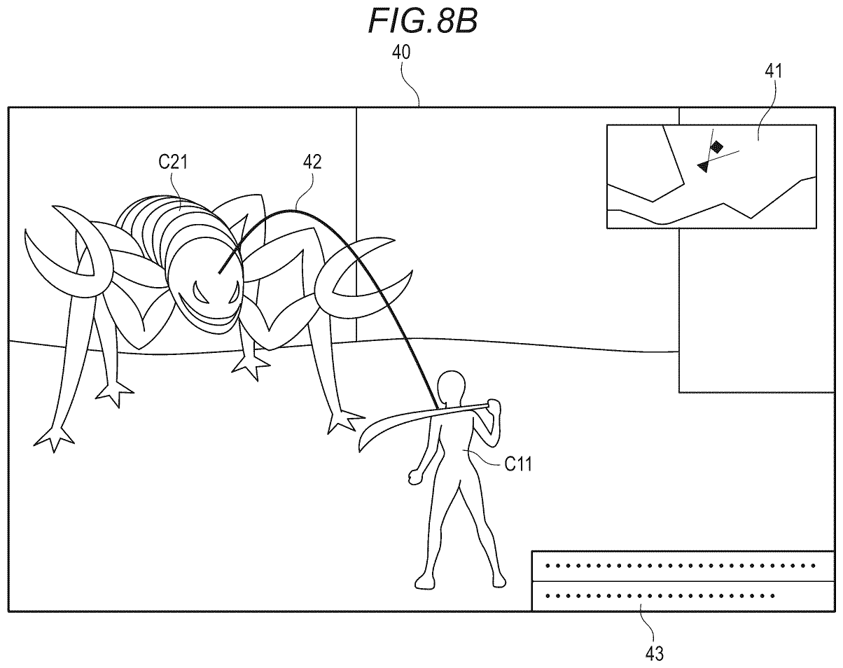

First, in step S11, the game field F1 may be selected according to the first user's operation on the user device 10. Once the game field F1 is selected, in step S12, the first user character C11 of the first user may be placed at a predetermined spawn position in the game field F1. When the first user character C11 spawns in the game field F1, a video that visually represents the game field F1 may be generated. The video of the game field F1 may be generated by rendering field configuration information n including objects in the game field F1, physical conditions (gravity, amount of light, and the like), and virtual camera setting information. The video of the game field F1 can be generated by using a known rendering engine. The video of the game field F1 represents the view of the game field F1 when viewed from the virtual camera. FIG. 8a shows an example of a video 40 of the game field F1. The video of the game field F1 shown in FIG. 8a may include images of the first user character C11 and the first computer character C21 as well as various objects in the game field F1. FIG. 8a shows a view of the game field F1 when viewed from a virtual camera placed behind the first user character C11. A view of a portion of the game field F1 when viewed from the Z-axis direction may be overlaid on the video 40 as a map. In the example shown, a map 41 showing an area including the first user character C11 in the game field F1 may be displayed in the upper right corner of the video 40. The placement of the first user character C11 and the first computer character C21 shown in FIG. 8a corresponds to the placement shown in FIG. 3a.

The video 40 may be displayed on the display of the user device 10. The first user can view the video 40 displayed on the user device 10 and perform an operation to move the first user character C11. The first user character C11 can move in the game field F1 according to the first user's operation on the user device 10.

When the first user character C11 is placed in the game field F1, in step S13, it may be determined whether the first user character C11 is placed in the encounterable zone of any computer character placed in the game field F1. The encounterable zone set for each computer character placed in the game field F1 may be stored as a part of the encounter management data 25c. When the first user character C11 is placed at the position shown in FIGS. 3b and 8a, it may be determined that the first user character C11 is not in the encounterable state because the first user character C11 is not in the encounterable zone of any computer character placed in the game field F1. The determination in step S13 may be performed, for example, every zone determination period until it is determined that the first user character C11 is in the encounterable state.

When the first user character C11 moves in a direction approaching the first computer character C21 from the position shown in FIG. 8a (position shown in FIG. 3a) according to the first user's operation on the user device 10, the first user character C11 may enter the encounterable zone Z11 of the first computer character C21. FIG. 8b shows the video 40 including the first user character C11 that has entered the encounterable zone Z11. The position of the first user character C11 shown in FIG. 8b may correspond to the position where the first user character C11 is placed in FIG. 3b.

When the first user character C11 enters the encounterable zone Z11 of the first computer character C21, the first user character C11 may transition from the normal state to the encounterable state.

When the first user character C11 transitions to the encounterable state, it may be possible to notify the first user that the first user character C11 has transitioned to the encounterable state by changing the game screen displayed on the user device 10 of the first user. For example, when the first user character C11 transitions to the encounterable state, a graphic element indicating that the first user character C11 may be in the encounterable state may be included in the video 40. For example, in the example shown in FIG. 8b, between the first user character C11 and the first computer character C21 that is in an encounterable state with respect to the first user character C11, a string-like graphic element 42 connecting both the characters to each other may be displayed. When the graphic element 42 is displayed between the first user character C11 and the first computer character C21, the first user can notice that the first computer character C21 has entered the encounterable zone Z11 of the first computer character C21. In the examples shown in FIGS. 8a and 8b, the boundary of the encounterable zone Z11 may not be included in the video 40. In this case, the first user may not be able to determine from the video 40 which area in the game field F1 is the encounterable zone Z11 until the first user character C11 enters the encounterable zone Z11. By making the graphic element 42 included in the video 40 when the first user character C11 is placed in the encounterable zone Z11, the first user can notice that the first user character C11 has entered the encounterable zone Z11 even if the boundary of encounterable zone Z11 is not included in the video 40.

When the first user character C11 is present in the encounterable zone Z11, characters indicating that the first user character C11 has entered the encounterable zone Z11 may be displayed in a text display area 43, in addition to the graphic element 42 or instead of the graphic element 42. It may also be possible to notify the first user that the first user character C11 is in the encounterable zone Z11 by means of production effects in the video 40 without display using the graphic element 42 or display using text or in addition to these displays. Such production effects may include changing the color tone of the entire video 40 (for example, changing the color tone so that the entire video 40 appears redder than when the first user character C11 is outside the encounterable zone Z11), generating sound effects, and vibrating the user device 10.

In one aspect, the boundary of the encounterable zone Z11 may be included in the video 40. By displaying the boundary of the encounterable zone Z11 in the video 40, the first user can move the first user character C11 to avoid the encounterable zone Z11, or conversely, move the first user character C11 to enter the encounterable zone Z11 in order to encounter the first computer character C21.

The processing in step S13 above may be performed by the zone determination unit 11b.

When it is determined in step S13 that the first user character C11 is present in the encounterable zone Z11 (that is, it is determined that the first user character C11 has transitioned to an encounterable state), the process may proceed to step S14. In step S14, it may be determined whether the first encounter event will occur. That is, in step S14, an event occurrence determination may be performed for the first user character C11. For example, whether the first encounter event will occur may be determined probabilistically based on the event occurrence probability, which is set for the first computer character C21, every event occurrence detection period set for the first computer character C21. When it is determined in the first event occurrence determination that an encounter event will not occur, the process may return to step S13. In step S13, it may be determined again whether the first user character C11 is present in the encounterable zone Z11. When the first user character C11 has already moved to the outside of the encounterable zone Z11 at this point in time, the determination result in step S13 this time may be NO, and the event occurrence determination for the next period may be not performed. On the other hand, when it is determined in step S13 that the first user character C11 is present in the encounterable zone Z11, the event occurrence determination for the next period may be performed in step S14. In this manner, the event occurrence determination in step S14 may be repeatedly performed every event occurrence determination period until it is determined that an encounter event has occurred in step S14 or until the first user character C11 moves outside the encounterable zone Z11 before the encounter event occurs and the encounterable state of the first user character C11 may be canceled.

When it is determined in step S14 that the first encounter event has occurred (that is, the first user character C11 has encountered the first computer character C21), the first encounter event may be executed in step S15. In step S15, for example, a battle event between the first user character C11 and the first computer character C21 may be executed as an encounter event.

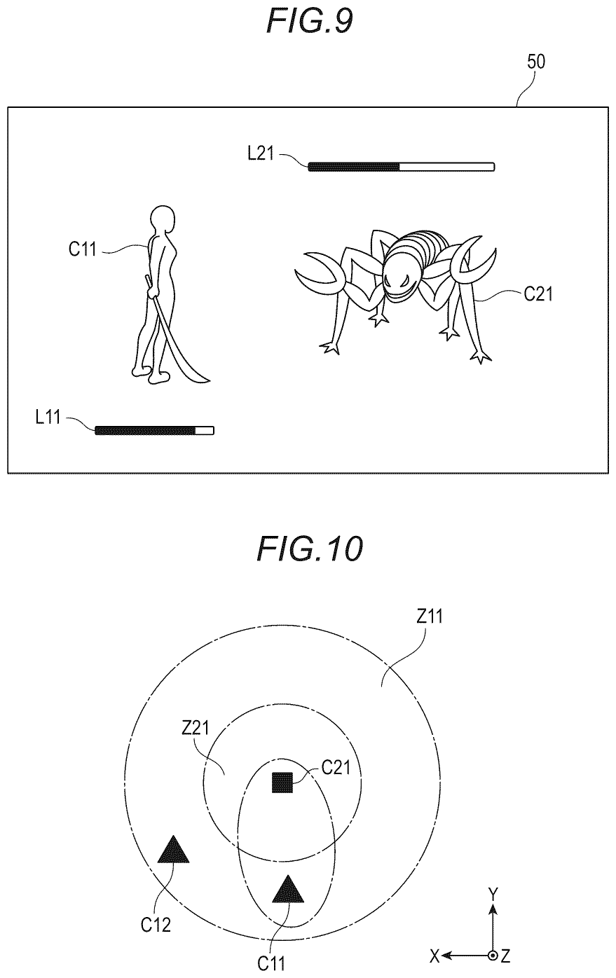

An example of processing in a battle event between the first user character C11 and the first computer character C21 will be described with reference to FIG. 9. FIG. 9 shows an example of a play screen 50 displayed on the user device 10 in response to the occurrence of a battle event. On the play screen 50, an image of the first user character C11 and an image of the first computer character C21 may be displayed.

On the play screen 50 displaying a battle event, life L11 may be displayed in association with the first user character C11, and life L21 may be displayed in association with the first computer character C21. When the first user character C11 is attacked, the life L11 may be reduced, and when the first computer character C21 is attacked, the life L21 may be reduced. Life may be recovered by using items or activating game effects such as magic. For example, a character who first reduces the opponent's life to zero wins the battle event.

Other characters can move in the game field F1 even while the first encounter event is in progress. For this reason, while the first encounter event is in progress, a user character other than the first user character C11 may enter the encounterable zone Z11 of the first computer character C21 participating in the first encounter event. In one aspect, even when a player character other than the first user character C11 may enter the encounterable zone Z11 of the first computer character C21 during the execution of the first encounter event, the zone determination unit 11b does not allow the user character to transition to an encounterable state. In other words, only when the first computer character C21 is not participating in the encounter event, the zone determination unit 11b may cause the user character that has entered the encounterable zone Z11 to transition to the encounterable state. For example, in the example shown in FIG. 10, the second user character C12 may enter the encounterable zone Z11 of the second user character C12 while the first encounter event is continuing. In this case, since the first computer character C21 may be participating in the encounter event with respect to the first user character C11, the second user character C12 may not transition to the encounterable state even after entering the encounterable zone Z11. Similarly, even when the second user character C12 moves to the contact zone Z21 during the execution of the first encounter event, an encounter between the second user character C12 and the first computer character C21 may not occur.

The second user character C12 can use a buff effect for the first user character C11 during the execution of the first encounter event. Due to the buff effect used by the second user character C12, abilities such as attack power and defense power of the first user character C11 may be strengthened in the first encounter event. In one aspect, the second user character C12 can use the buff effect for the first user character C11 playing against the first computer character C21 only when the second user character C12 is placed in the encounterable zone Z11 of the first computer character C21. When the second user character C12 is far away from the first user character C11 and the second computer character C22 participating in the first encounter event in the game field F1, the second user character C12 may not be able to use a buff effect for the first user character C11, but may be able to use the buff effect only when the second user character C12 approaches the first computer character C21 until the second user character C12 enters the encounterable zone Z11 of the first computer character C21.

When the first encounter event ends as either the first user character C11 or the first computer character C21 wins the battle, the first user character C11 may return to the game field F1 in step S16. In this case, the first user character C11 may be placed at the same position as when the first encounter event has occurred. The first user can move the first user character C11 in the game field F1 again by operating the first user character C11 that has returned to the game field F1.

As described above, determination of an encounter between the first user character C11 and the first computer character C21 placed in the game field F1 and processing of the first encounter event in the case of an encounter may be performed.

The first user character C11 can encounter computer characters other than the first computer character C21 placed in the game field F1.

The first user character C11 may also encounter other user characters (for example, the second user character C12 or the third user character C13) placed in the game field F1. The encounter event that occurs when user characters encounter each other may be a conversation event in which the user characters have a conversation with each other or a transaction event in which the user characters trade items with each other. When the game system 1 provides a function that allows user characters to play against each other, an encounter event that occurs when the user characters encounter each other may be a battle event between the user characters.

User characters other than the first user character C11 placed in the game field F1 can also encounter other computer characters and/or other user characters in the game field F1 in the same manner as the first user character C11. Encounter determination for user characters other than the first user character C11 can also be performed according to the method shown in the flowchart of FIG. 7.

### 7. Modification Examples of Encounterable Zone

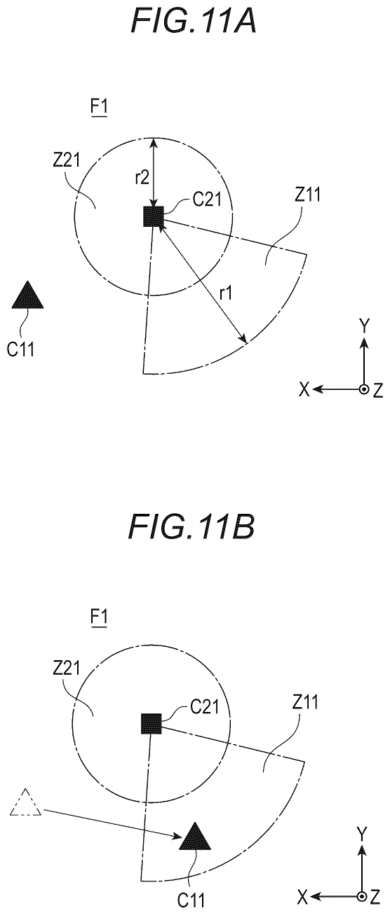

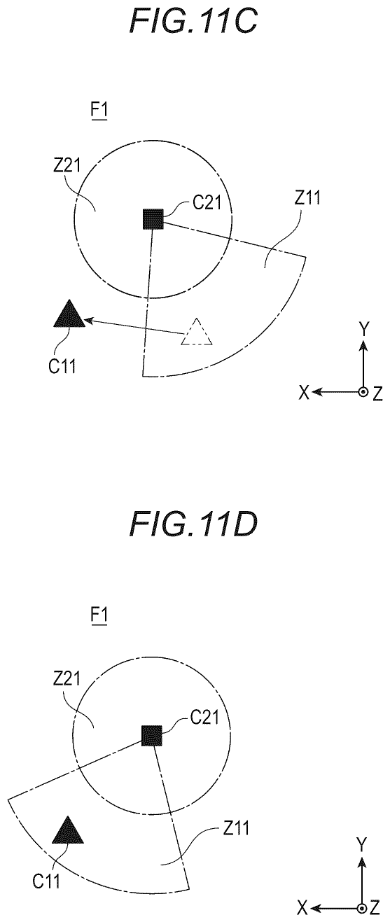

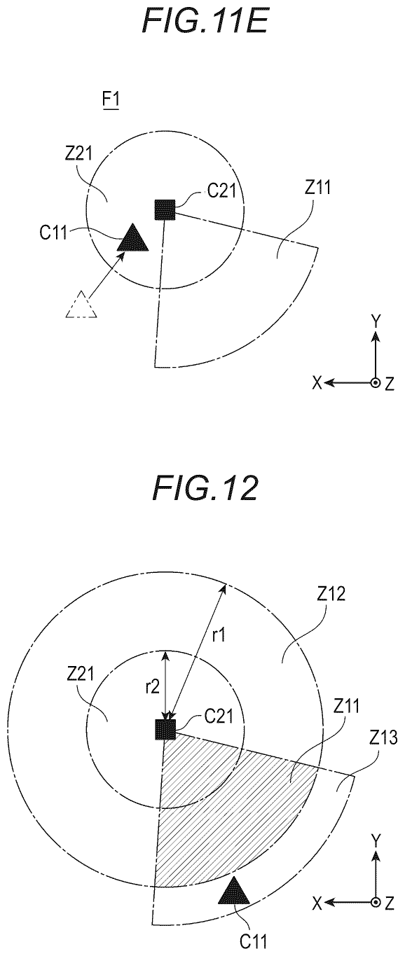

In FIGS. 3a to 3e, an embodiment has been described in which the encounterable zone Z11 of the first computer character C21 may be a zone in a circle centered on the first computer character C21. The shape of the encounterable zone Z11 in the game field F1 that can be applied to an exemplary embodiment may not be limited to a circle. Therefore, modification examples of the encounterable zone Z11 will be described below with reference to FIGS. 11a to 11e.

As shown in FIG. 11a, the encounterable zone Z11 may have a non-circular shape in the XY plane of the game field F1. FIG. 11a shows, as an example of the non-circular encounterable zone Z11, the encounterable zone Z11 having a fan shape centered on the first computer character C21 and having a radius r1 and a central angle of approximately 60°. The fan-shaped encounterable zone Z11 may correspond to the field of view of the first computer character C21.

When the first computer character C21 has the fan-shaped encounterable zone Z11, even if the first user character C11 enters an area having a radius r1 from the first computer character C21, the first user character C11 may not enter the encounterable zone Z11 as shown in FIG. 11a. When the first user character C11 moves to the position shown in FIG. 11a, the distance from the first computer character C21 may be smaller than r1, but the first user character C11 may be placed outside the encounterable zone Z11. Therefore, the first user character C11 does not transition to the encounterable state. As shown in FIG. 11b, the first user character C11 may move into the fan-shaped encounterable zone Z11 to transition to the encounterable state. In addition, as shown in FIG. 11c, the first user character C11 can leave the encounterable zone Z11 by moving to the blind spot of the first computer character C21 without moving away from the first computer character C21.

In one aspect, the encounterable zone Z11 can be moved in the game field F1. For example, the encounterable zone Z11 can move according to the movement of the line of sight of the first computer character C21. The first computer character C21 may be controlled to track the first user character C11 that has left the encounterable zone Z11 according to the movement of the line of sight. For example, as shown in FIG. 11d, by rotating the line of sight clockwise around the position of the first computer character C21, the first user character C11 that has moved to the blind spot in FIG. 11c can be tracked by the first computer character C21 based on the rotation of the line of sight of the first computer character C21, which causes the first user character to again be placed within the encounterable zone Z11.

When the encounterable zone Z11 does not surround the first computer character C21, the first user character C11 can enter the contact zone Z21 without entering the encounterable zone Z11. For example, as shown in FIG. 11e, the first user character C11 can enter the contact zone Z21 from the blind spot of the first computer character C21 while avoiding the encounterable zone Z11. Entering the contact zone Z21 may cause an encounter event. When the first user character C11 enters the contact zone Z21 without entering the encounterable zone Z11, an encounter event may be made to occur under conditions that may be more advantageous to the first user character C11 than when an encounter event occurs after the first user character C11 enters the encounterable zone Z11 (for example, when an encounter event occurs due to event occurrence determination while the first user character C11 is placed in the encounterable zone Z11 or when an encounter event occurs when the first user character C11 enters the encounterable zone Z11 and then enters the contact zone Z21). For example, when the encounter event is a turn-based battle event, the battle event may be started with the first user character C11. In addition, when the encounter event is a turn-based battle event, the first few turns (for example, three turns) may allow only the first user character C11 to attack instead of alternating attacks.

For the first computer character C21, a perception zone for perceiving the presence of the user character may be set in addition to the encounterable zone Z11. The perception zone of the first computer character C21 may be a zone that occupies a part of the game field F1 defined in association with the first computer character C21, and may indicate the range of perception of the first computer character C21. In one aspect, when a user character enters the perception zone of the first computer character C21, the first computer character C21 can perceive the presence of the user character. When the first computer character C21 perceives the presence of the user character, the first computer character C21 can track the user character by moving in a direction approaching the user character. When the first computer character C21 perceives the presence of the user character, it may be possible to draw the user character toward the first computer character C21. The perception zone of the first computer character C21 may be, for example, a visual zone corresponding to the field of view of the first computer character C21. The perception zone of the first computer character C21 may be, for example, an auditory zone corresponding to the hearing threshold value of the first computer character C21. When the user character performs an action that makes a sound (for example, talking, moving, using an item) while being in the auditory zone of the first computer character C21, the first computer character C21 may be able to perceive that the user character may be present in its auditory zone. The perception zone of the first computer character C21 may be, for example, an olfactory zone representing the olfactory threshold value of the first computer character C21. When the odor emitted by the user character exceeds the olfactory threshold value set for the olfactory zone while the user character is present in the olfactory zone of the first computer character C21, the first computer character C21 may be able to perceive that the user character is present in its olfactory zone. The odor emitted by the user character can be determined based on the user character's equipment and items, attributes of the user character, and other factors.

Still another example of the encounterable zone Z11 will be described with reference to FIG. 12. In the example shown in FIG. 12, of a perception zone Z13 of the first computer character C21, a zone overlapping a proximity zone Z12 whose distance from the first computer character C21 is within r1 may be set as the encounterable zone Z11. In other words, of the perception zone Z13 of the first computer character C21, a zone whose distance from the first computer character C21 is within r1 may be set as the encounterable zone Z11.

In the example shown in FIG. 12, since the first user character C11 may be placed outside the encounterable zone Z11, the first user character C11 may not be in an encounterable state. However, since the first user character C11 may be placed inside the perception zone Z13, the first computer character C21 can perceive the presence of the first user character C11 and track the first user character C11.

In one aspect, the perception zone of the first computer character C21 may match the encounterable zone Z11.

Still another example of the encounterable zone Z11 will be described with reference to FIG. 13. As shown in FIG. 13, the encounterable zone Z11 does not include the first computer character C21 and does not need to be in contact with the first computer character C21. That is, the encounterable zone Z11 of the first computer character C21 may be placed at a position spaced apart from the first computer character C21 in the game field F1. By setting the encounterable zone Z11 of the first computer character C21 at a position away from the first computer character C21, it is possible to set the encounterable zone Z11 reflecting the attributes or characteristics of the first computer character C21. For example, for a computer character who is good at exploring or attacking a remote area, by setting the encounterable zone Z11 at a position away from the computer character, it may be possible to set the encounterable zone Z11 that is compatible with the attributes of the computer character.

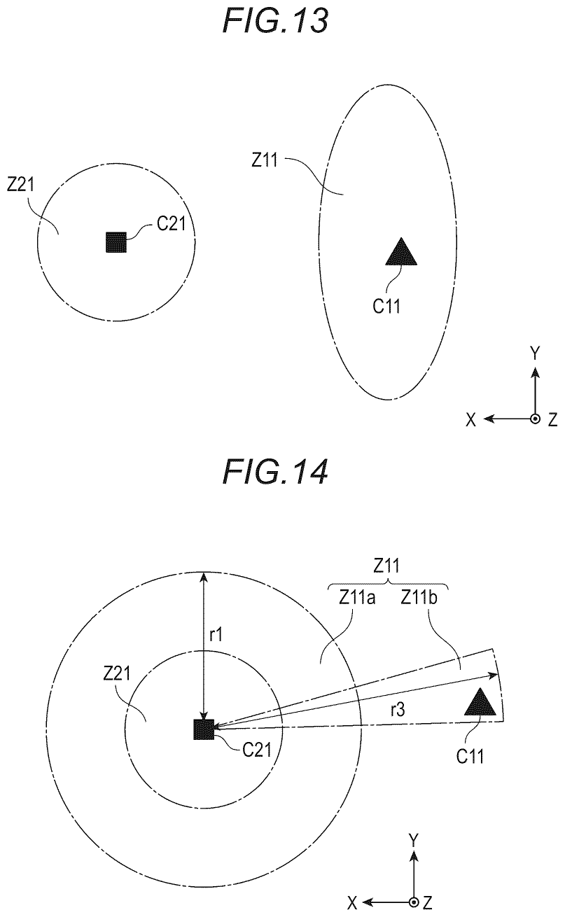

Still another example of the encounterable zone Z11 will be described with reference to FIG. 14. The encounterable zone Z11 may be configured by combining two or more subzones. In the example shown in FIG. 14, the encounterable zone Z11 of the first computer character C21 may include a first subzone Z11a and a second subzone Z11b. In this case, when the first user character C11 may be present inside either the first subzone Z11a or the second subzone Z11b, it may be determined that the first user character C11 is in an encounterable state. In the example shown, the first subzone Z11a may be a zone in a circle having a radius r1 from the first computer character C21, and the second subzone Z11b may be a fan-shaped inner zone centered on the first computer character C21 and having a radius r3 and a central angle of approximately 15°. The radius r3 may be larger than the radius r1. For example, by setting the second subzone Z11b to include a direction in which the line of sight of the first computer character C21 faces, the encounterable zone Z11 can be set so as to be wide in the direction in which the line of sight of the first computer character C21 faces and narrow in other directions.

The event occurrence probability set for the first subzone Z11a may be different from the event occurrence probability set for the second subzone Z11b. That is, the event occurrence determination may be performed by applying different event occurrence probabilities in a case where the first user character C11 is in an encounterable state because the first user character C11 is present in the first subzone Z11a and a case where the first user character C11 is in an encounterable state because the first user character C11 is present in the second subzone Z11b. The event occurrence determination period set for the first subzone Z11a may be different from the event occurrence determination period set for the second subzone Z11b.

8. Encounter Event in which Plurality of User Characters can Participate

For some computer characters placed in the game field F1, it may be possible for other user characters to participate in an encounter event while the encounter event is being executed between the computer character and the user character. The following explanation will be given on the assumption that, for the second computer character C22, other user characters can participate in an encounter event while the encounter event is being executed between the first user character C11 and the second computer character C22.

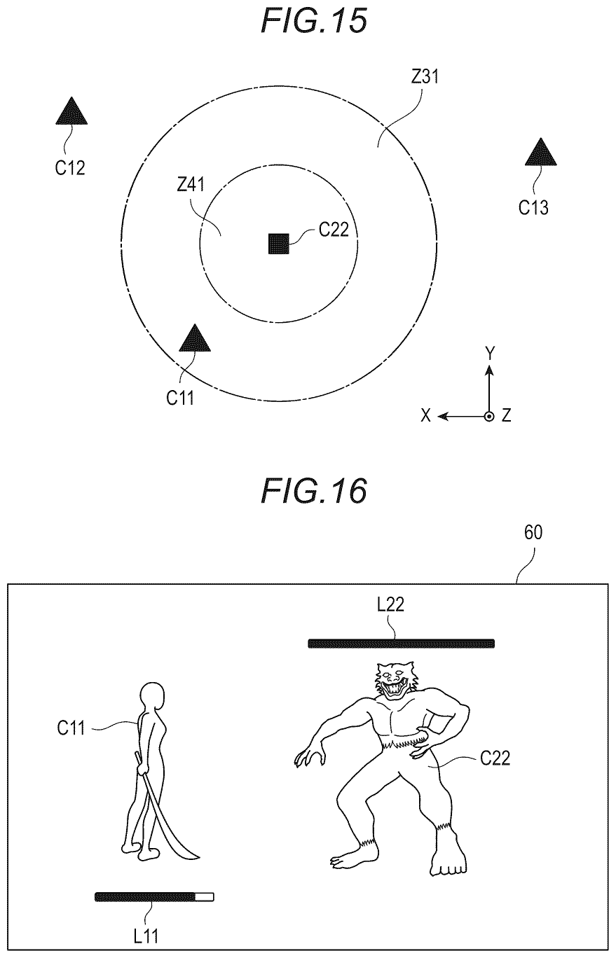

As shown in FIG. 15, when the first user character C11 is present in an encounterable zone Z31 of the second computer character C22, the first user character C11 can encounter the second computer character C22. When the first user character C11 is in the encounterable state, an event occurrence determination may be performed as described above, and an encounter event in which the first user character C11 and the second computer character C22 participate occurs according to the result of the event occurrence determination. Hereinafter, for ease of description, the encounter event in which the first user character C11 and the second computer character C22 participate may be referred to as a “second encounter event”. Even when the first user character C11 enters a contact zone Z41 of the second computer character C22, the second encounter event occurs. The explanation regarding the encounterable zone Z11 of the first computer character C21 also applies to the encounterable zone Z31 of the second computer character C22. In addition, the explanation regarding the contact zone Z21 of the first computer character C21 also applies to the contact zone Z41 of the second computer character C22.

When the second encounter event is a battle event, a play screen 60 shown in FIG. 16 may be displayed on the user device 10. On the play screen 60, an image of the first user character C11 and an image of the second computer character C22 may be displayed. On the play screen 60, life L11 may be displayed in association with the first user character C11, and life L22 may be displayed in association with the second computer character C22. In the battle event, a character who first reduces the opponent's life to zero wins the battle event.

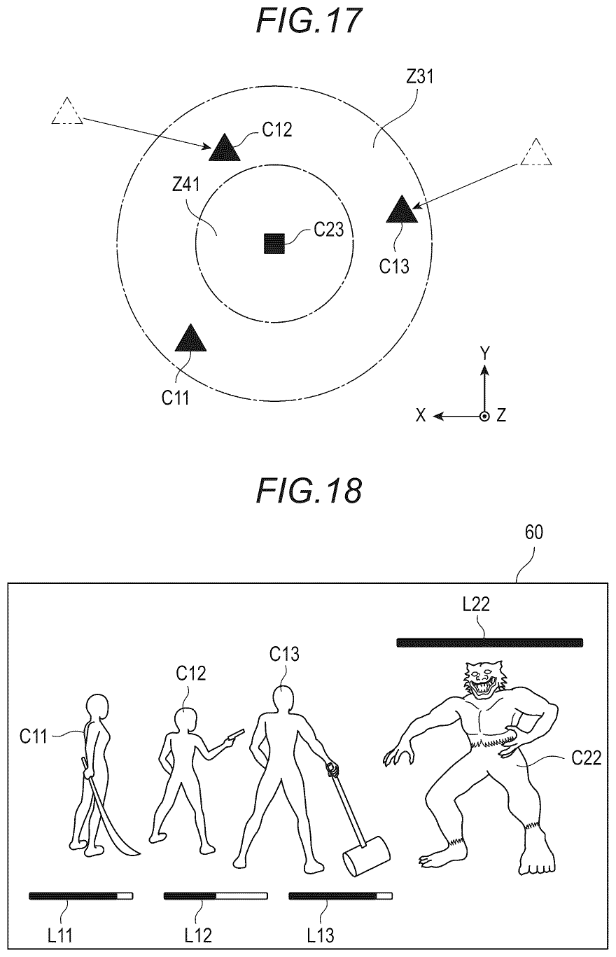

When another player character satisfies predetermined participation conditions while the second encounter event is being executed, another player character can participate in the second encounter event. For example, as shown in FIG. 17, in response to the second user character C12 entering the encounterable zone Z31 of the second computer character C22 while the second encounter event is being executed, the second user character C12 can be made to participate in the second encounter event. Specifically, when the zone determination unit 11b determines that the second user character C12 has entered the encounterable zone Z31 of the second computer character C22, the second user character C12 can participate in the second encounter event. The third user character C13 can also participate in the second encounter event like the second user character C12. When the second user character C12 and the third user character C13 participate in the second encounter event, the second user character C12 and the third user character C13 may be added to the play screen 60 as shown in FIG. 18.

While the second encounter event is being executed, the settings regarding the encounterable zone Z31 of the second computer character C22 may be changed compared to when the second encounter event is not executed. For example, while the second encounter event is being executed, the encounterable zone Z31 of the second computer character C22 may be expanded. That is, the area of the encounterable zone Z31 while the second encounter event is being executed may be larger than the area of the encounterable zone Z31 while the second encounter event is not being executed. This makes it easier for user characters other than the first user character C11 to participate in the second encounter event. In addition, the shape of the encounterable zone Z31 while the second encounter event is being executed may be different from the shape of the encounterable zone Z31 while the second encounter event is not being executed. In addition, the event occurrence determination period in the encounterable zone Z31 while the second encounter event is being executed may be different from the event occurrence determination period in the encounterable zone Z31 while the second encounter event is not being executed.

As participation conditions for allowing other user characters (for example, the second user character C12) to participate in an event (second encounter event) in which the first user character C11 and the second computer character C22 participate, the following conditions can be mentioned in addition to entering the encounterable zone Z31.
(1) It is detected that the second user character C12 has entered the contact zone Z41 of the second computer character C22 while the second encounter event is being executed. Detection of entry into the contact zone Z41 can be performed by the zone determination unit 11b.
(2) The first user has invited the second user of the second user character C12 to the second encounter event.
(3) The second user character C12 is placed in the game field F1 while the second encounter event is being executed.

Participation conditions for allowing other user characters to participate in the second encounter event are not limited to the above conditions.

In the example shown in FIG. 18, the second user character C12 and the third user character C13 may be participating in a battle event between the first user character C11 and the second computer character C22. The first user character C11, the second user character C12, and the third user character C13 can cooperate to fight against the second computer character C22.

### 9. Functions and Effects

Next, some of the functions and effects realized by the above embodiment will be described.

In the encounter determination in one embodiment, when it may be determined that the first user character C11 is in an encounterable state because the first user character C11 is present in the encounterable zone Z11 of the first computer character C21, an event occurrence determination may be performed to determine whether to generate an encounter event between the first user character C11 in the encounterable state and the first computer character C21. According to the result of the event occurrence determination, the first user character C11 may encounter the second computer character C22 and an encounter event occurs. Therefore, by adopting the encounter determination in one embodiment, unlike conventional random encounters, an encounter event does not occur forcibly based only on the probability. For this reason, the user can move in the game field F1 without encountering the first computer character C21 by moving in the virtual field so as to avoid the encounterable zone Z11 of the first computer character C21. Therefore, by the encounter determination in one embodiment, it may be possible to solve or alleviate the problems of the conventional random encounters due to encounter events being forced to occur based only on the probability.

In addition, in one embodiment, instead of automatically generating an encounter event in response to the first user character C11 entering the encounterable zone Z11, it may be determined that the first user character C11 in the encounterable zone Z11 is in an encounterable state, and an event occurrence determination may be further performed to determine whether to generate an encounter event between the first computer character C21 and the first user character C11 determined to be in an encounterable state. In this manner, even when the first user character C11 enters the encounterable zone Z11 of the first computer character C21, an encounter may not be automatically established. Therefore, it may be possible to solve or alleviate the problems of the conventional random encounters caused by the forced occurrence of an encounter event due to approaching another character. For example, even when a computer character may be placed at a bottleneck in the game field F1, it may be possible to avoid encountering the computer character placed at the bottleneck by moving the first user character C11 so that the staying time in the encounterable zone set for the computer character may be short and passing through the bottleneck. In this manner, according to one embodiment, since a situation in which encounters are unavoidable may be difficult to occur, it may be possible to suppress the degradation of the user experience due to the forced occurrence of an encounter event.

In one embodiment, a user who desires to cause an encounter with the first t computer character C21 can voluntarily generate an encounter event with respect to the first computer character C21 by making the first user character C11 enter the contact zone Z21 of the first computer character C21. Therefore, the first user can generate an encounter event with respect to the first computer character C21 by operating the first user character C11 without waiting for the encounter event to occur probabilistically.

In conventional symbol encounters, when a character as an encounter opponent is large, an opponent character displayed on the game screen may become too large when a user character enters the encounter area of the encounter opponent and an encounter determination may be performed. When the display of the opponent character is too large during the encounter, only a part of the opponent character may be displayed on the screen during the encounter, making it difficult to see the appearance of the opponent character the user character may encounter. For this reason, when transitioning to an encounter event, it may be difficult to understand the identity between the opponent character before the transition and the opponent character in the encounter event. Thus, when the symbol encounter is adopted when the sizes of characters as encounter opponents are different, there may be a risk that an unnatural impression may be given to the user during the encounter. By enlarging the encounter area for an opponent character with a large appearance, it may be possible to cause an encounter before the opponent character becomes too large on the game screen. In this case, however, many encounter events with respect to opponent characters with large appearances occur. Therefore, it may be difficult to maintain an appropriate game balance. According to the embodiment described in this specification, the above problems in conventional symbol encounters can be solved. That is, according to the embodiment described in this specification, by setting a large encounterable zone for a computer character with a large appearance, the user character can transition to an encounterable state before the computer character is displayed in a large size on the game screen (before becoming close enough to make such a display). In addition, even when the encounterable zone for a computer character with a large appearance is enlarged, the problem of too frequent encounters with the computer character with a large appearance does not occur by reducing the probability of encounter occurrence in the encounterable zone or increasing the event occurrence determination period.

10. Applications Other than Games

The exemplary embodiments disclosed in this specification can also be applied to applications other than games. For example, the exemplary embodiments described in this specification can be used in determining an encounter between user characters (avatars) placed in the metaverse space. In the metaverse space, interactions between users, work in which a plurality of users participate, play in which a plurality of users participate, and other social activities in the real world may be virtually reproduced. Users can participate in the metaverse space through their avatars. Users' avatars can freely walk around the world of the metaverse space and communicate with each other. In an embodiment in which the exemplary embodiments described in this specification are applied to the metaverse space, the encounterable zone Z11 that occupies a part of the area in the metaverse space may be set for a first avatar placed in the metaverse space. Then, when a second avatar enters the encounterable zone Z11, it may be determined that the second avatar is in an encounterable state, and whether the second avatar is allowed to encounter the first avatar can be determined based on the event occurrence probability every event occurrence determination period.

### 11. Notes

The game system 1 shown in FIG. 1 may be an example of a system to which an exemplary embodiment can be applied, and the game system to which an exemplary embodiment can be applied may not be limited to that shown in FIG. 1. The game system 1 to which an exemplary embodiment can be applied may not include some of the components shown. For example, the game system 1 may not include the storage 30. The game system 1 may include components that are not shown. Although only one user device 10 may be shown in FIG. 1 to simplify the explanation, the game system 1 can include any number of user devices 10 equal to or greater than two. The game system 1 may include a cloud environment for distributed processing of processing to be executed by the user device 10 or the server 20.

In the game system 1, there may be no particular restriction on the storage location of data. For example, various data that can be stored in the storage 15 may be stored in a storage (for example, the storage 30) that may be physically separated from the storage 15 or in a database server. In this specification, data described as being stored in the storage 15 may be stored in a single storage, or may be stored in a plurality of storages in a distributed manner. In addition, in this specification and the claims, the term “storage” may refer to either a single storage or a collection of a plurality of storages as long as the context allows. The above explanation regarding data that can be stored in the storage 15 also applies to data stored in the storage 25 to the extent possible.

An exemplary embodiment may not be limited to the embodiment described above, and various changes can be made without departing from the gist thereof. For example, some or all of the functions executed by the processor 11 and the processor 21 may be realized by a processor not specified in this specification without departing from the spirit of the invention. Although the processor 11 may be shown as a single component in FIG. 1, the processor 11 may be a collection of a plurality of physically separate processors. The same applies to the processor 21. In this specification, programs described as being executed by the processors 11 and 21 or instructions included in the programs may be executed by a single processor, or may be executed in a distributed manner by a plurality of processors. In addition, the programs executed by the processors 11 and 21 or the instructions included in the programs may be executed by one or more virtual processors.

The programs executed by the processor 11 and/or the processor 21 may be stored in various types of non-transitory computer readable media in addition to the storage shown. Non-transitory computer readable media include various types of tangible storage media. Examples of non-transitory computer readable media include magnetic recording media (for example, a flexible disk, a magnetic tape, and a hard disk drive), magneto-optical recording media (for example, a magneto-optical disk), a compact disc read only memory (CD-ROM), a CD-R, a CD-R/W, and semiconductor memories (for example, a mask ROM, a programmable ROM (PROM), an erasable PROM (EPROM), a flash ROM, and a random access memory (RAM)).

Even if the processes and procedures described in this specification may be described as being performed by a single device, software, component, or module, such processes or procedures may be performed by a plurality of devices, a plurality of pieces of software, a plurality of components, and/or a plurality of modules. In addition, even if the data, tables, or databases described in this specification may be described as being stored in a single memory, such data, tables, or databases can be stored in a distributed manner in a plurality of memories included in a single device or in a plurality of memories arranged in a distributed manner in a plurality of pieces of equipment. In addition, the software and hardware elements described in this specification can be implemented by integrating these into fewer components or decomposing these into more components.

In the processing procedures described in this specification, particularly in the processing procedures described using the flowcharts or sequence diagrams, some of the processes (steps) included in the processing procedures can be omitted, a step that is not specified as a step included in the processing procedure can be added, and/or the order of the steps can be changed. Processing procedures with such omissions, additions, and changes in order may also be included within the scope of an exemplary embodiment without departing from the spirit of the invention.

In this specification and the claims, expressions such as “first,” “second,” and “third” may be used to identify components, and do not necessarily limit the number, order, or content thereof. In addition, numbers for identifying components may be used for each context, and numbers used in one context do not necessarily indicate the same component in other contexts. In addition, this does not prevent a component identified by a certain number from having the function of a component identified by another number.

### 12. Supplementary Notes

The following technologies may also be disclosed in this specification.

[Supplementary note 1]

A system, including:
one or more processors,
in which, when a first character operated by a first user is present in an encounterable zone set in association with a second character in a virtual field, the one or more processors determine that the first character is in a first encounterable state in which there is a possibility of encounter between the first character and the second character, and
when the first character is in the first encounterable state, the one or more processors determine whether to generate a first encounter event in which the first character and the second character participate.

### [Supplementary Note 2]

The system described in [Supplementary note 1],
in which the encounterable zone is a zone within a first distance from a position where the second character is placed in the virtual field.

### [Supplementary Note 3]

The system described in [Supplementary note 1] or [Supplementary NOTE 2],
in which a perception zone indicating a perception range of the second character is set in the virtual field, and
the encounterable zone is located inside the perception zone.
   [Supplementary note 4]

The system described in any one of [Supplementary note 1] to [Supplementary note 3],
in which a perception zone indicating a perception range of the second character is set in the virtual field, and
the encounterable zone is a zone inside the perception zone within a predetermined distance from a position where the second character is placed in the virtual field.

### [Supplementary Note 5]

The system described in any one of [Supplementary note 1] to [Supplementary note 4],
in which the encounterable zone is a zone not including the second character.

### [Supplementary Note 6]

The system described in any one of [Supplementary note 1] to [Supplementary note 5],
in which the encounterable zone includes a first subzone and a second subzone.

### [Supplementary Note 7]

The system described in any one of [Supplementary note 1] to [Supplementary note 6],
in which an event occurrence rate indicating a probability that the first encounter event will occur in the encounterable zone is set for the second character, and
when the first character is in the first encounterable state, whether to generate the first encounter event is determined based on the event occurrence rate every event occurrence determination period.

### [Supplementary Note 8]

The system described in [Supplementary note 7],
in which the event occurrence rate changes with a staying time during which the first character stays in the encounterable zone.

### [Supplementary Note 9]

The system described in [Supplementary note 7] or [Supplementary note 8],
in which the event occurrence rate changes with a distance between the first character and the second character.

### [Supplementary Note 10]

The system described in any one of [Supplementary note 1] to [Supplementary note 9],
in which a contact zone, which is a zone within a second distance smaller than a first distance from a position where the second character is placed, is set in the virtual field, and
the first encounter event occurs in response to the first character entering the contact zone in the virtual field.

### [Supplementary Note 11]

The system described in any one of [Supplementary note 1] to [Supplementary note 10],
in which a game screen displayed for the user is changed in response to transition of the first character to the first encounterable state.

### [Supplementary Note 12]

The system described in [Supplementary note 3],
in which the one or more processors display, in the virtual field, a graphic element indicating that the first character is in the perception zone.

### [Supplementary Note 13]

The system described in [Supplementary note 12],
in which the graphic element is displayed between the first character and the second character.

### [Supplementary Note 14]

The system described in [Supplementary note 2],
in which, when the first character is present in the perception zone, the second character moves in a direction approaching the first character in the virtual field.

### [Supplementary Note 15]

The system described in any one of [Supplementary note 1] to [Supplementary note 14],
in which the one or more processors generate a second encounter event in which the first character and a third character placed in the virtual field participate, and
the one or more processors cause a fourth character operated by a second user different from the first user to further participate in the second encounter event.

### [Supplementary Note 16]

The system described in any one of [Supplementary note 1] to [Supplementary note 15],
in which, when a fourth character operated by a second user different from the first user is present in the encounterable zone, the one or more processors do not allow the fourth character to transition to an encounterable state in which there is a possibility of encounter between the second character and the fourth character while the first encounter event is being executed.

### [Supplementary Note 17]

A game processing method, including:
a first determination step in which, when a first character operated by a first user is present in an encounterable zone set in association with a second character in a virtual field, it is determined that the first character is in a first encounterable state in which there is a possibility of encounter between the first character and the second character; and
a second determination step in which, when the first character is in the first encounterable state, it is determined whether to generate a first encounter event in which the first character and the second character participate.

### [Supplementary Note 18]

A game program causing one or more processors to execute:
a first determination step in which, when a first character operated by a first user is present in an encounterable zone set in association with a second character in a virtual field, it is determined that the first character is in a first encounterable state in which there is a possibility of encounter between the first character and the second character; and
a second determination step in which, when the first character is in the first encounterable state, it is determined whether to generate a first encounter event in which the first character and the second character participate.

### REFERENCE SIGNS LIST

1 game system
10 user device
11 processor
11a game progression unit
11b zone determination unit
11c event occurrence determination unit
11d event execution unit
15 storage
15a game application
15b encounter management data
20 server

1. A system, comprising:
a memory and one or more processors, wherein the memory comprises instructions configuring the one or more processors to:
wherein, when a first character operated by a first user is present in an encounterable zone set in association with a second character in a virtual field, determine that the first character is in a first encounterable state in which there is a possibility of encounter between the first character and the second character, and
when the first character is in the first encounterable state, determine whether to generate a first encounter event in which the first character and the second character participate.

2. The system according to claim 1,
wherein the encounterable zone is a zone within a first distance from a position where the second character is placed in the virtual field.

3. The system according to claim 1,
wherein a perception zone indicating a perception range of the second character is set in the virtual field, and
the encounterable zone is located inside the perception zone.

4. The system according to claim 1,
wherein a perception zone indicating a perception range of the second character is set in the virtual field, and
the encounterable zone is a zone inside the perception zone within a predetermined distance from a position where the second character is placed in the virtual field.

5. The system according to claim 1,
wherein the encounterable zone is a zone not including the second character.

6. The system according to claim 1,
wherein the encounterable zone includes a first subzone and a second subzone.

7. The system according to claim 1,
wherein an event occurrence rate indicating a probability that the first encounter event will occur in the encounterable zone is set for the second character, and
when the first character is in the first encounterable state, the one or more processors are configured to determine whether to generate the first encounter event based on the event occurrence rate every event occurrence determination period.

8. The system according to claim 7,
wherein the event occurrence rate changes with a staying time during which the first character stays in the encounterable zone.

9. The system according to claim 7,
wherein the event occurrence rate changes with a distance between the first character and the second character.

10. The system according to claim 8,
wherein the event occurrence rate further changes with a distance between the first character and the second character.

11. The system according to claim 1,
wherein a contact zone is set in the virtual field, wherein said contact zone is a zone within a second distance smaller than a first distance from a position where the second character is placed, and
wherein the one or more processors are configured to trigger the first encounter event in response to the first character entering the contact zone in the virtual field.

12. The system according to claim 1,
wherein a game screen displayed for the first user is changed in response to a transition of the first character to the first encounterable state.

13. The system according to claim 3,
wherein the one or more processors are configured to display, in the virtual field, a graphic element indicating that the first character is in the perception zone.

14. The system according to claim 13,
wherein the graphic element is displayed between the first character and the second character.

15. The system according to claim 3,
wherein, when the first character is present in the perception zone, the one or more processors are configured to move the second character in a direction approaching the first character in the virtual field.

16. The system according to claim 1,
wherein the one or more processors are configured to generate a second encounter event in which the first character and a third character placed in the virtual field participate, and
the one or more processors are configured to cause a fourth character operated by a second user different from the first user to further participate in the second encounter event.

17. The system according to claim 1,
wherein, when a fourth character operated by a second user different from the first user is present in the encounterable zone, the one or more processors are configured not to allow the fourth character to transition to an encounterable state in which there is a possibility of encounter between the second character and the fourth character while the first encounter event is being executed.

18. A game processing method executed by one or more processors executing computer-readable instructions, the game processing method comprising:
a first determination step in which, when a first character operated by a first user is present in an encounterable zone set in association with a second character in a virtual field, it is determined that the first character is in a first encounterable state in which there is a possibility of encounter between the first character and the second character; and
a second determination step in which, when the first character is in the first encounterable state, it is determined whether to generate a first encounter event in which the first character and the second character participate.

19. A non-transitory computer-readable medium comprising a game program that, when executed on one or more processors, is configured to cause the one or more processors to execute:
a first determination step in which, when a first character operated by a first user is present in an encounterable zone set in association with a second character in a virtual field, it is determined that the first character is in a first encounterable state in which there is a possibility of encounter between the first character and the second character; and
a second determination step in which, when the first character is in the first encounterable state, it is determined whether to generate a first encounter event in which the first character and the second character participate.
